(19) United States
(12) Patent Application Publication
(10) Pub. No.: US 2026/0176052 A1
(43) Pub. Date: Jun. 25, 2026

(54) AEROSOL FOAM DISPENSER

(71) Applicant: THE PROCTER & GAMBLE COMPANY, Cincinnati, OH (US)

(72) Inventors: Andrew William FRANCKHAUSER, Batavia, OH (US); Michael David O'Young MUI, Mason, OH (US); Morgan Renee SAILOR, Dayton, OH (US); Eric Edward SHELTON, Mason, OH (US); Christopher Lawrence SMITH, Fairfield Township, OH (US); Geoffrey Allen KING, London, OH (US); Jules Ellis SIEGEL, Dayton, OH (US)

(21) Appl. No.: 19/407,299

(22) Filed: Dec. 3, 2025

Related U.S. Application Data
(60) Provisional application No. 63/735,922, filed on Dec. 19, 2024.

(51) Int. Cl. B65D 83/28; B65D 83/141; B65D 83/20

(52) U.S. Cl. CPC B65D 83/28; B65D 83/141; B65D 83/20

(57) ABSTRACT

An aerosol foam dispenser having a container configured to contain a composition and a propellant; a valve assembly in fluid communication with the container; and an actuator assembly. The actuator assembly includes a supply channel in fluid communication with the valve assembly; a nozzle in fluid communication with the supply channel and configured to atomize the composition; an expansion chamber; a porous barrier extending in a direction substantially parallel to an outer end surface of the nozzle; and an actuator in operative communication with the valve assembly. The expansion chamber includes a sidewall having an air vent extending therethrough.

### CROSS REFERENCE TO RELATED APPLICATIONS

This application claims the benefit, under 35 U.S.C. § 119(e), to U.S. Provisional Application No. 63/735,922, filed Dec. 19, 2024, the entire disclosure of which is fully incorporated by reference herein.

### FIELD OF THE INVENTION

The present disclosure relates generally to aerosol foam dispensers and more specifically to aerosol foam dispensers having an actuator assembly configured to create a foam without the use of a soluble propellant.

### BACKGROUND OF THE INVENTION

Insects and other arthropod pests can have negative effects on the quality of human life. For instance, when found in the home, insects and other arthropods can be a source of annoyance due purely to their presence. They may also spread disease and allergens. A number of pest control products exist today to control various pests and the market for pest control products, especially products that contain natural ingredients (e.g., plant essential oils), is growing. While products that contain natural ingredients exist today, they may have a number of disadvantages: some products have limited efficacy; some products are not recommended for use on food contact surfaces; some products do not provide an optimal scent experience, e.g., emit a long-lasting, unpleasant odor; some products do not provide optimal neat product aesthetics, e.g., appear cloudy, or turbid, and/or off color; some products may be phase unstable at cold temperatures (i.e., about 5° C. to 10° C.) or separate into multiple phases and require a consumer to vigorously shake the product before use; and some products may be messy to use and/or may leave a residue on a treated surface.

Furthermore, the direct application of many existing pest control compositions to a pest involves monitoring by a consumer to determine product efficacy. For example, after a consumer applies a pest control composition to a target pest (e.g., ants, flies, cockroaches), the consumer typically observes the pest for signals of incapacitation, including twitching of wings, legs, or antennae and/or the inability of the pest to right itself. In addition, after a pest control composition is applied to a pest, the pest may attempt to run or fly away. Some consumers may prefer to use a liquid pest control composition that is converted to a foam upon dispensing as the foam may immobilize, trap, and/or conceal the incapacitated pest from the consumer's view.

Traditional aerosol foaming dispensers rely on soluble propellants to create a foam. However, soluble propellants can cause the composition to suffer from stability issues and/or may undesirably change the pH of the composition. As such, there is a need for an aerosol foam dispenser that does not rely on the use of a soluble propellant to create a foam. There is also a need for a foam that is sufficiently thick to conceal the pest but does not last for an overly extended period of time and/or require extensive wiping by a consumer to remove.

### SUMMARY OF THE INVENTION

The present disclosure solves the problem of creating a foam using an aerosol dispenser without the use of soluble propellants by creating an actuator assembly comprising a nozzle configured to atomize the composition, an expansion chamber configured to introduce air into the flow path, and a porous barrier, such as a screen, that shears the atomized particles to create a foam.

Described herein is an aerosol foam dispenser comprising: a pressurized container configured to contain a composition and a propellant; a valve assembly in fluid communication with the container; and an actuator assembly. The actuator assembly comprises: a supply channel in fluid communication with the valve assembly; a nozzle in fluid communication with the supply channel and configured to atomize the composition; an expansion chamber comprising a side wall, a first end region, and a laterally opposing second end region, wherein the first end region is in fluid communication with the outlet orifice, and wherein the side wall comprises an air vent extending therethrough; a porous barrier extending in a direction substantially parallel to an outer end surface of the nozzle, wherein the porous barrier is positioned adjacent to the second end region of the expansion chamber; and an actuator in operative communication with the valve assembly. The nozzle comprises: a substantially cup-shaped nozzle insert having an outlet orifice and a nozzle body for receiving and retaining the nozzle insert. The nozzle body is in fluid communication with the supply channel for receiving a composition to be atomized and comprising an insert post having an end surface. The nozzle comprises a swirl chamber in fluid communication with a plurality of generally radial vanes and the outlet orifice disposed generally concentric with the swirl chamber and in fluid communication therewith. The plurality of radial vanes is in fluid communication with the supply channel.

Also described herein is an aerosol foam dispenser comprising: a pressurized container configured to contain a composition and a compressed gas propellant, wherein the pressure in the container is from about 170 kPa to about 1150 kPa at 21° C.; a valve assembly in fluid communication with the container; and an actuator assembly. The actuator assembly comprises: a supply channel in fluid communication with the valve assembly; a nozzle in fluid communication with the supply channel and configured to atomize the composition; an expansion chamber comprising a side wall, a first end region, and a laterally opposing second end region, wherein the first end region is in fluid communication with the outlet orifice, and wherein the side wall comprises an air vent extending therethrough; a porous barrier extending in a direction substantially parallel to an outer end surface of the nozzle; and an actuator in operative communication with the valve assembly. The nozzle comprises: a substantially cup-shaped nozzle insert having an outlet orifice and a nozzle body for receiving and retaining the nozzle insert. The nozzle body is in fluid communication with the supply channel for receiving a composition to be atomized and comprising an insert post having an end surface. The nozzle comprises a swirl chamber in fluid communication with a plurality of generally radial vanes and the outlet orifice disposed generally concentric with the swirl chamber and in fluid communication therewith. The plurality of radial vanes is in fluid communication with the supply channel. The porous barrier is positioned adjacent to the second end region of the expansion chamber. A flow rate of the composition discharged from the actuator assembly as measured without the porous barrier present is in the range of about 2 g/s to about 10 g/s and a flow rate of the composition discharged from the actuator assembly as measured with the porous barrier present is in the range of about 1 g/s to about 7 g/s.

Also described herein is an aerosol foam dispenser comprising: a pressurized container configured to contain a composition and a compressed gas propellant; a valve assembly in fluid communication with the container; and an actuator assembly. The actuator assembly comprising: a supply channel in fluid communication with the valve assembly; a nozzle in fluid communication with the supply channel and configured to atomize the composition; an expansion chamber comprising a side wall, a first end region and a laterally opposing second end region, wherein the first end region is in fluid communication with the outlet orifice, wherein the side wall comprises an air vent extending therethrough; a screen extending in a direction substantially parallel to an outer end surface of the nozzle, wherein the screen is positioned adjacent to the second end region of the expansion chamber, the screen having a mesh size of from about 20 to about 40; and an actuator in operative communication with the valve assembly. The nozzle comprises: a substantially cup-shaped nozzle insert having an outlet orifice and a nozzle body for receiving and retaining the nozzle insert. The nozzle body is in fluid communication with the supply channel for receiving a composition to be atomized and comprising an insert post having an end surface. The nozzle comprises a swirl chamber in fluid communication with a plurality of generally radial vanes and an outlet orifice disposed generally concentric with the swirl chamber and in fluid communication therewith. The plurality of radial vanes is in fluid communication with the supply channel. The expansion chamber has a chamber length from about 7.0 mm to about 9.0 mm.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of an aerosol foam dispenser.

FIG. 2 is a side view of an aerosol foam dispenser.

FIG. 3 is a sectional view of a portion of an aerosol foam dispenser illustrating a dispenser shroud, an actuator assembly, an actuator, and a valve stem.

FIG. 4 is an exploded view of a dispenser shroud and actuator assembly of an aerosol foam dispenser.

FIG. 5 is a side view of an aerosol foam dispenser without an actuator assembly or base cup.

FIG. 6 is a sectional view of an aerosol foam dispenser having a composition delivery device in the form of a bag.

FIG. 7 is a sectional view of an aerosol foam dispenser having a composition delivery device in the form of a dip tube.

FIG. 8 is a sectional view of an actuator assembly.

FIG. 9 is a sectional view of a portion of an example nozzle including a nozzle body and a nozzle insert.

FIG. 10 is a sectional view of a portion of another example nozzle including a nozzle body and a nozzle insert.

FIG. 11 is an elevation view of the interior of an example nozzle insert having grooves, a swirl chamber, and an outlet orifice.

FIG. 12 is a perspective view of the nozzle insert of FIG. 11 having grooves, a swirl chamber, and an outlet orifice.

FIG. 13 is a sectional view of the nozzle insert of FIG. 11.

FIG. 14 is a sectional view of the nozzle insert of FIG. 11.

FIG. 15 is a schematic frontal view of a screen passageway.

### DETAILED DESCRIPTION OF THE INVENTION

In this specification and in the claims that follow, reference will be made to a number of terms that shall be defined to have the following meanings unless a contrary intention is apparent.

As used herein, articles such as “a” and “an” when used in a claim, are understood to mean one or more of what is claimed or described.

“Geologically derived” means derived from, for example, petrochemicals, natural gas, or coal. “Geologically derived” materials cannot be easily replenished or regrown (e.g., in contrast to plant- or algae-produced materials).

The term “renewable” is synonymous with the terms “natural,” “bio-derived”, “bio-based,” and means that a material is derived from substances derived from living organisms, such as farmed plants, rather than, for example, geologically derived, e.g., coal-derived or petroleum-derived.

As used herein, the term “renewable component” refers to a component that is derived from renewable feedstock and contains renewable carbon. A renewable feedstock is a feedstock that is derived from a renewable resource, e.g., plants, and non-geologically derived. A material may be partially renewable (less than 100% renewable carbon content, or from about 1% to about 90% renewable carbon content, or from about 1% to about 80% renewable carbon content, or from about 1% to about 60% renewable carbon content, or from about 1% to about 50% renewable carbon content) or 100% renewable (100% renewable carbon content). A renewable feedstock may be blended or chemically reacted with a geologically derived feedstock, resulting in a material with a renewable component and a geologically derived component.

“Renewable carbon” may be assessed using the “Assessment of the Biobased Content of Materials” method, ASTM D6866-16.

The term “substantially free of” or “substantially free from” as used herein refers to either the complete absence of an ingredient or a minimal amount thereof merely as impurity or unintended byproduct of another ingredient. A composition that is “substantially free” of/from a component means that the composition comprises less than about 0.5%, less than about 0.25%, less than about 0.1%, less than about 0.05%, or less than about 0.01%, all by weight of the composition, of the component.

As used herein, the terms “include”, “includes” and “including” are meant to be non-limiting.

The compositions of the present disclosure can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

An aerosol foam dispenser may include a container configured to contain a composition, a valve assembly in fluid communication with the container, and an actuator assembly configured to atomize and aerate the composition upon dispensing such that a foam is created. The container may be configured to contain a propellant that is substantially insoluble in the composition or is physically separated from the composition.

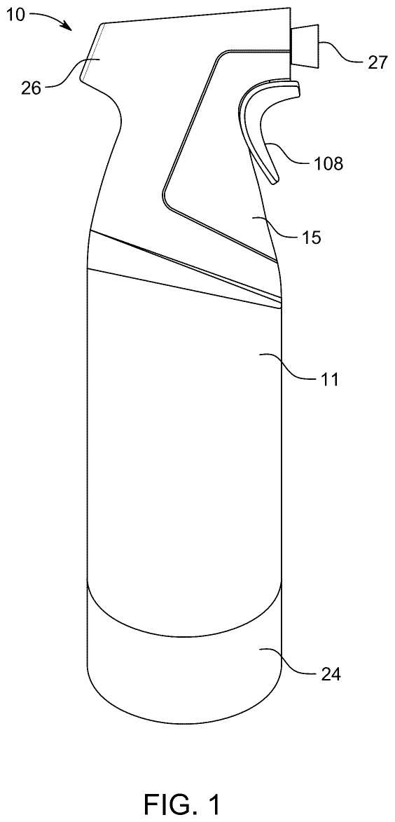

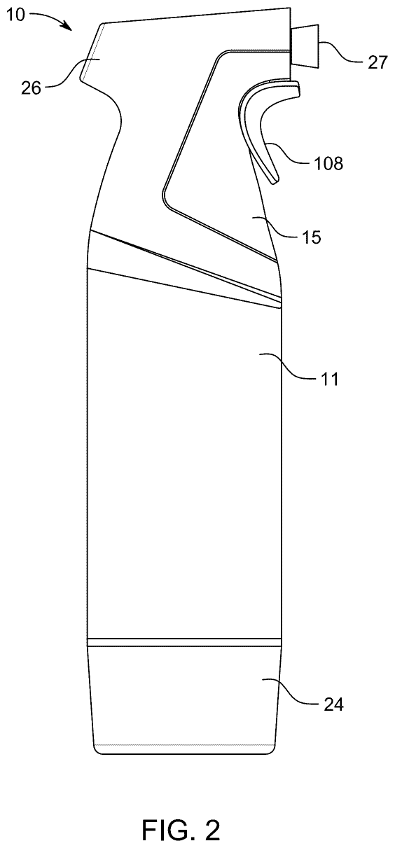

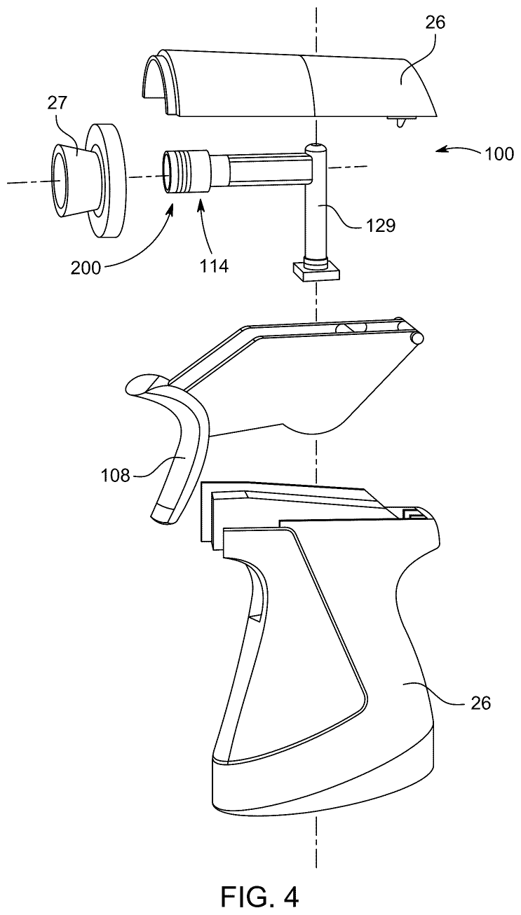

With reference to FIGS. 1-7, an aerosol foam dispenser 10 may include a container 11, a valve assembly 30 in fluid communication with the container 11, an actuator assembly 100, and an exit shroud 27. The aerosol foam dispenser 10 has a transverse (lateral) axis T and a longitudinal axis L. The transverse axis T extends perpendicular to the longitudinal axis L. The actuator assembly 100 may comprise an actuator 108 in operative communication with a valve assembly 30, a supply channel 132 of a manifold 129 in fluid communication with the valve assembly 30, which, in turn is in fluid communication with a nozzle 114, and an expansion chamber 200. Portions of the valve assembly 30, actuator assembly 100, and exit shroud 27 may be at least partially contained within or in operative communication with a dispenser shroud 26. The dispenser shroud 26 may comprise a grip region 15 which can provide a surface for the user to hold the dispenser. The dispenser shroud 26 may provide ergonomic functionality to the dispenser and/or may improve aesthetics of the dispenser by hiding some components.

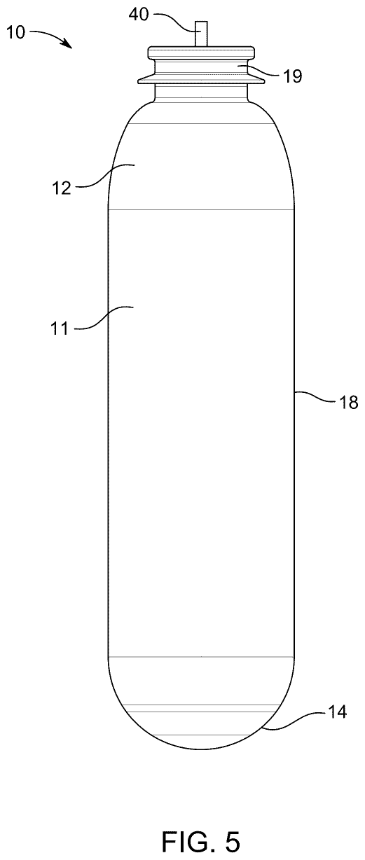

With reference to FIGS. 5-7, the container 11 may include a first end portion 12, a second end portion 14, and a sidewall 18 extending between the first and second end portions 12 and 14. The container 11 defines an interior 16. The first end portion 12 of the container 11 includes a neck 19 defining an opening 21. The container 11 may be configured to contain a composition and a propellant in the interior 16.

The container 11 may be any shape that allows the composition and/or propellant to be held within the interior of the container. For example, the container may be peanut-shaped, cylindrical-shaped, oval-shaped, or rectangular-shaped. It is to be appreciated that the container 11 may be molded, which allows for any number of shapes to be used. The container 11 may be longitudinally elongated such that the container has an aspect ratio of a longitudinal dimension to a transverse dimension, such as diameter. The aspect ratio may be greater than 1, equal to 1, such as in a sphere or shorter cylinder, or less than 1. The container may be cylindrical.

The container 11 may be configured for resting on horizontal surfaces such as shelves, countertops, tables etc. In some configurations, the second end portion 14 may be configured to rest on a horizontal surface. The second end portion 14 of the container 11 may include a base cup 24. The base cup 24 may be joined to the second end portion 14 of the container 11 and may aid in reinforcement of the second end portion 14 and/or may allow the container to rest on horizonal surfaces. In some configurations, the container 11 may not include a base cup and may be configured to sit on at least a portion of the second end portion 14. Suitable shapes of the second end portion 14 include petaloid, champagne, hemispherical, or other generally convex or concave shapes. Each of these shapes of the second end portion 14 may be used with or without a base cup 24. The container 11 may have a generally flat base. This flat base may be formed from the bottle itself with a possible indent.

The container 11 may be comprised of various materials including metal or plastic. The container 11 may include polyethylene terephthalate (PET), polyethylene furanoate (PEF), polyester, nylon, polyolefin, ethylene vinyl alcohol (EVOH), or mixtures thereof. The container 11 may be a single layer or multi-layered. In some configurations, the container 11 may be injection molded or blow molded, such as in an injection-stretch blow molding process or an extrusion blow molding process.

The container 11 may range from about 5 cm to about 60 cm, or from about 10 cm to about 40 cm in height, taken in the axial direction. The container 11 may have a perimeter of from about 50 mm to about 350 mm, or from about 60 mm to about 250 mm, or a diameter from about 15 mm to about 100 mm, or from about 20 mm to about 80 mm. The container may have a volume of from about 40 cubic centimeters to about 1,000 cubic centimeters, exclusive of any components therein such as a composition delivery device 54.

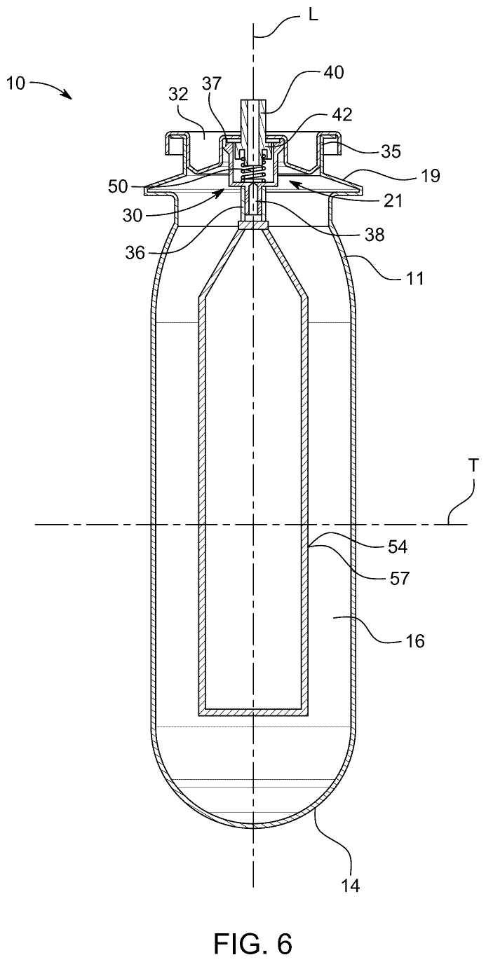

With reference to FIGS. 6-7, the aerosol foam dispenser 10 may include a composition delivery device 54. The composition delivery device 54 may be used to contain and/or provide for delivery of the composition from the foam dispenser 10 upon demand. In some configurations, the delivery device 54 may be a compartment (such as a piston or a collapsible bag 57 as illustrated in FIG. 6) configured to hold a composition therein and separate the composition from a propellant, such as a liquified gas propellant. In other configurations, the delivery device 54 may be a dip tube 55 such as illustrated in FIG. 7. The composition delivery device 54 may comprise polyethylene terephthalate (PET), polypropylene (PP), polyethylene furanoate (PEF), polyester, nylon, polyolefin, EVOH, or mixtures thereof. When the composition delivery device 54 is in the form of a bag 57 (see FIG. 6), a liquified gas propellant may be disposed within the container 11 and/or between the container and the bag. A portion of bag 57 may be joined to at least one of the container 11 and a portion of the valve assembly 30. The bag 57 may be inserted into the container 11 and subsequently joined thereto. Alternatively, the bag 57 may be joined to a portion of the valve assembly 30, and the valve assembly joined to the bag may be subsequently inserted into the container 11.

The container 11 and/or the composition delivery device 54 may be transparent or substantially transparent. This arrangement provides the benefit that the consumer knows when composition is nearing depletion and allows improved communication of composition attributes, such as color, viscosity, etc. Also, indicia disposed on the container, such as labeling or other decoration of the container, may be more apparent if the background to which such decoration is applied is clear. Labels may be shrink wrapped, printed, etc., as are known in the art.

At 21° C., the container 11 may be pressurized to an internal gage pressure of about 170 kPa to about 1150 kPa, or from about 350 kPa to about 1050 kPa, or from about 500 kPa to about 900 kPa using a propellant. The container 11 may have an initial internal gage pressure at 21° C. of from about 800 kPa to about 1150 kPa and a final internal gage pressure at 21° C. of from about 170 kPa to about 245 kPa. The volumetric ratio of composition to propellant may be from about 90/10 to about 50/50, or from about 40/60 to about 70/30, or from about 50/50 to about 60/40.

The propellant may be a compressed gas propellant such as nitrogen, air, carbon dioxide, or nitrous oxide, or a liquified gas such as propane, isobutane, n-butane, isopentane, n-pentane, dimethyl ether, or hydrofluoro-olefin. In some configurations, the propellant is a compressed gas, preferably nitrogen or air, more preferably nitrogen. The propellent may be non-flammable. Along with the particular type of gas, the amount of headspace provided by the gas can be adjusted or tailored as desired. Because compressed gases do not significantly dissolve in the liquid composition, the amount of headspace is primarily a function of the amount of compressed gas used in the container. A headspace of about 10% to about 50%, or about 30% to about 40%, may be used. Alternatively, the headspace may be less than about 30%, or greater than about 40%.

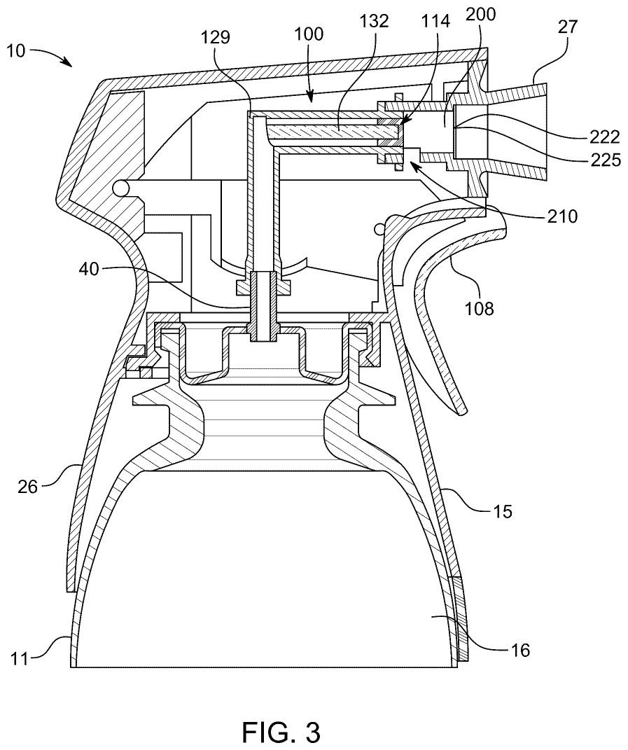

As previously mentioned, aerosol foam dispenser 10 may include a valve assembly 30 in fluid communication actuator assembly 100. With reference to FIGS. 3, and 6-8, the valve stem 40 of valve assembly 30 may be in fluid communication with a supply channel 132 of a manifold 129, which, in turn, is in fluid communication with the nozzle 114. The supply channel extends from the exit of the valve stem 40 (the start of the manifold 129) and extends through to the exit of the outlet orifice 144 adjacent the expansion chamber 200. The nozzle 114 directs the composition out of the container 11 and into the expansion chamber 200. The actuator 108 may be engaged by a user and is configured to initiate and terminate dispensing of the composition. Stated another way, the actuator 108 provides selective dispensing of the composition. The actuator 108 may be depressible, operable as a trigger, push-button, and the like, to cause release of a composition from the aerosol foam dispenser 10. The actuator 108 may be operatively connected with the valve assembly 30 and/or the dispenser shroud 26.

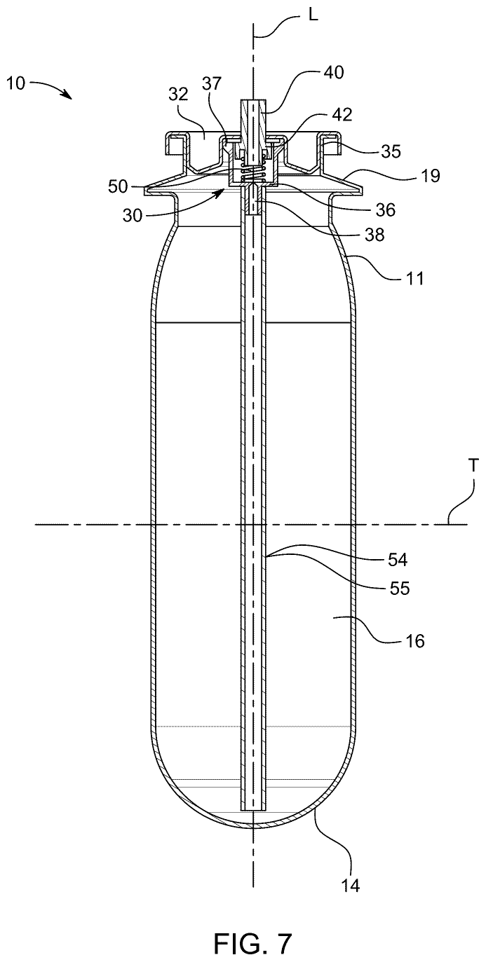

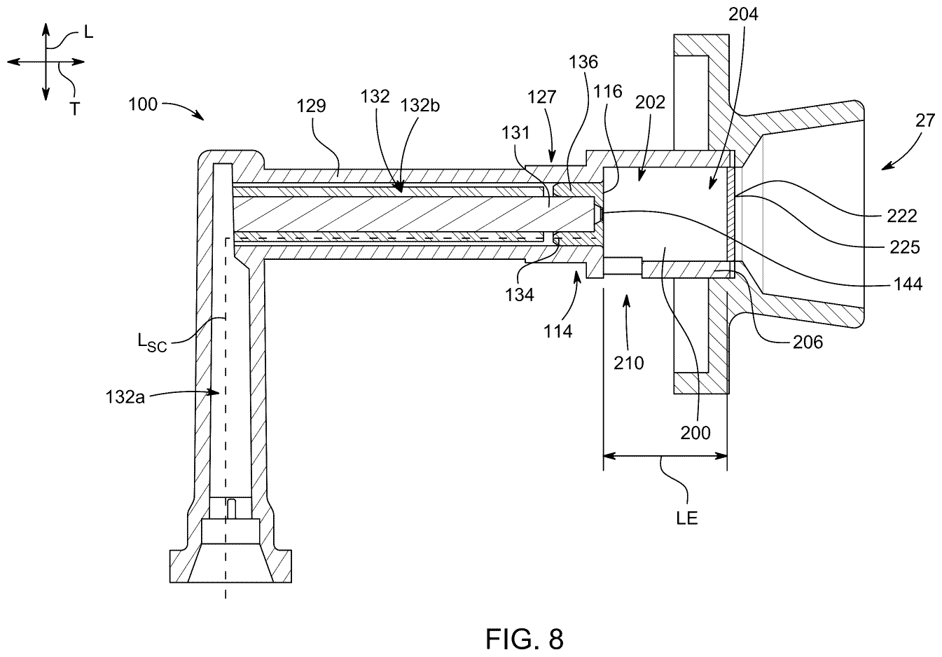

As shown in FIG. 8, the supply channel 132 may be defined by a supply channel length L_{SC} that is measured along a central axis of the fluid flow through the supply channel 132 of the manifold 129. The supply channel length L_{SC} is measured from the start of the supply channel 132 and manifold 129 adjacent to the valve stem 40 to the exit of the outlet orifice 144 at the opposite end of the manifold. The supply channel length L_{SC} may be from about 70 mm to about 120 mm, or from about 80 mm to about 110 mm, or from about 85 mm to about 100 mm. In some configurations, the supply channel length L_{SC} may be at least 70 mm, or at least 80 mm, or at least 90 mm.

The supply channel 132 may have a first portion 132a and a second portion 132b. The first portion 132a may extend substantially parallel to the longitudinal axis L of the aerosol foam dispenser 10, and the second portion 132b may extend substantially parallel to the transverse axis T of the aerosol foam dispenser 10. The first portion 132a of supply channel 132 may have a first diameter and the second portion 132b of supply channel 132 may have a second diameter. In some configurations, the first diameter may be less than the second diameter. In some configurations, the first diameter may be from about 3 mm to about 10 mm, or from about 4 mm to about 8 mm, and the second diameter may be from about 5 mm to about 15 mm, or from about 6 mm to about 12 mm. The ratio of the first diameter to the second diameter may be from about 2:5 to about 9:10, or from about 1:2 to about 4:5. Without being limited by theory, it is believed that the change in diameter and/or the change in direction of the supply channel can reduce the flow rate of the composition as it moves through the supply channel, nozzle, expansion chamber, and/or porous barrier. Without being limited by theory, it is believed that a consumer desirable foam may not form if the flow rate is too high (i.e., greater than about 10 g/s).

The valve assembly 30 may be at least partially disposed in the opening 21 of container 11 and may be joined to a portion of a mounting cup 32, such as illustrated in FIGS. 6 and 7. A mounting gasket (not shown) may be disposed between an upper rim 35 of container 11 and the underside of the mounting cup 32. The term “joined” as used throughout this disclosure includes directly or indirectly joined. “Joined” includes removably joined and fixedly joined. “Joined” includes both mechanical attachment, such as by screws, bolts, interference fit, friction fit, crimping, welding, and integrally molding, and chemical attachment, such as by adhesive or the adhesive properties inherent in the materials being attached.

The valve assembly 30 may comprise a valve body 36 and a valve stem 40. The valve stem 40 may include a lower portion 42 that extends through a return spring 50. An upper rim 37 of the valve body 36 may be affixed to the underside of the mounting cup 32 by a friction fit and the valve stem 40 may extend through the mounting cup 32. Gaskets may or may not be provided between the valve body 36 and the mounting cup 32, and between the valve stem 40 and the mounting cup 32, depending upon the materials used for each component. Suitable materials that will permit a gasket-less construction will be apparent to those skilled in the art. The composition delivery device 54 may be joined to a lower end 38 of the valve body 36 and the composition delivery device 54 may be in fluid communication with the valve stem 40. The composition and the propellant may be stored in the container 11. Upon being dispensed, the composition may travel from and/or through the composition delivery device 54 and through the valve assembly 30.

At least a portion of the valve assembly 30 may be movable in order to open and close the aerosol foam dispenser for dispensing the composition. The valve assembly 30 may be opened due to movement of the valve stem 40 which may be through use of an actuator 108 or through manual or other mechanical depression and/or tilting of the valve stem 40. When the valve is opened, for example, by way of the actuator 108, a fluid flow path is created for the composition to be dispensed through actuator assembly 100 to ambient or a target surface. The valve assembly 30 may be opened, for example, by selective actuation of the actuator 108 by a user.

The valve stem 40 provides a flow path for the composition from the interior 16 of the container 11 to the supply channel 132. The valve stem 40 is in operative communication with the actuator 108. The valve stem 40 may be positioned with respect to the valve body 36 in a closed position such that valve stem 40 is not in fluid communication with the composition delivery device 54. The valve stem 40 may be moveable with respect to the valve body 36, for example between a closed position and a fully open position. When the valve stem 40 is in the fully open position, the valve stem opening is in fluid communication with the composition delivery device 54. The valve stem 40 may include a valve stem channel that is in fluid communication with the valve stem opening through which the composition may flow out from the container 11. The valve assembly 30, including the valve body 36 and valve stem 40, may be constructed from any substantially rigid material, such as steel, aluminum, or their alloys, fiberglass, or plastic.

With reference to FIGS. 8-10, the nozzle 114 comprises a nozzle body 127 and a nozzle insert 136. The nozzle body 127 may be integral with the manifold 129 or may be a separate structure that is attached to the manifold 129 by mechanical means. Nozzle body 127 may be provided with a generally cylindrically shaped interior and may have various external configurations or structures which may aid the user in operation of the dispenser (e.g., raised gripping surfaces, depressions for finger placement and the like). The supply channel 132 may extend through the nozzle body 127 for receiving nozzle insert 136. The supply channel 132 may define an inside wall 134. The nozzle insert 136 may be joined with the nozzle body 127 by, for illustrative purposes only, a frictional interference fit between the inside wall 134 and the nozzle insert 136 and optionally the insert post 131. The frictional connection, more commonly known as a press fit, between nozzle insert 136 and supply channel 132 may be snug but removable to facilitate cleaning or rinsing of debris which may otherwise build up and clog the nozzle.

The corresponding surfaces of supply channel 132 and nozzle insert 136 are provided of appropriate size and material to effectively create a seal therebetween so that there will be generally no liquid flow between the surfaces when the dispenser is in operation. It will be understood by one skilled in the art that nozzle insert 136 may be connected to supply channel 132 by means other than a frictional interference fit such as adhesive connections, welding, mechanical connecting structures (e.g., threads, tabs, slots, ring, or the like), or by integral manufacture with supply annulus. Nozzle insert 136 may be configured to provide fluid communication with the container 11 so that the composition to be dispensed may be transported from the container 11 to the nozzle 114.

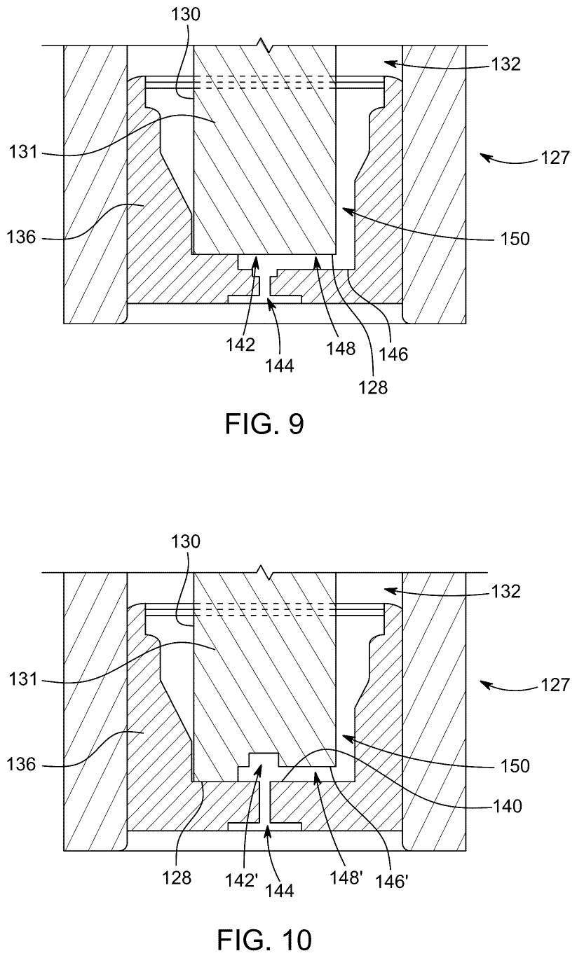

An insert post 131 may be disposed adjacent nozzle insert 136, as best illustrated in FIGS. 9 and 10. Insert post 131 may have a substantially planar end surface 128 adjacent its distal end, and insert post surface 130. End surface 128 may be generally circular shaped. Insert post 131 may be a separate structure which may be attached to nozzle body 127 by a mechanical means (e.g., threaded, press fit or the like), or may be integrally formed with nozzle body 127 for simplicity of manufacture (such as by injection molding). Supply channel 132 generally forms a supply annulus 150 which is bounded by post surface 130 and inside wall 134. The supply channel 132 may be adjacent to and in fluid communication with nozzle insert 136 to initially receive fluid from the container 11.

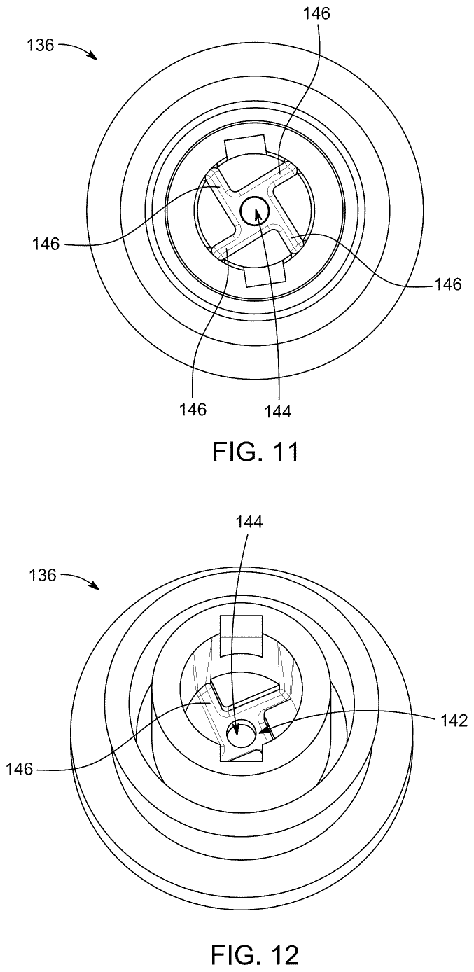

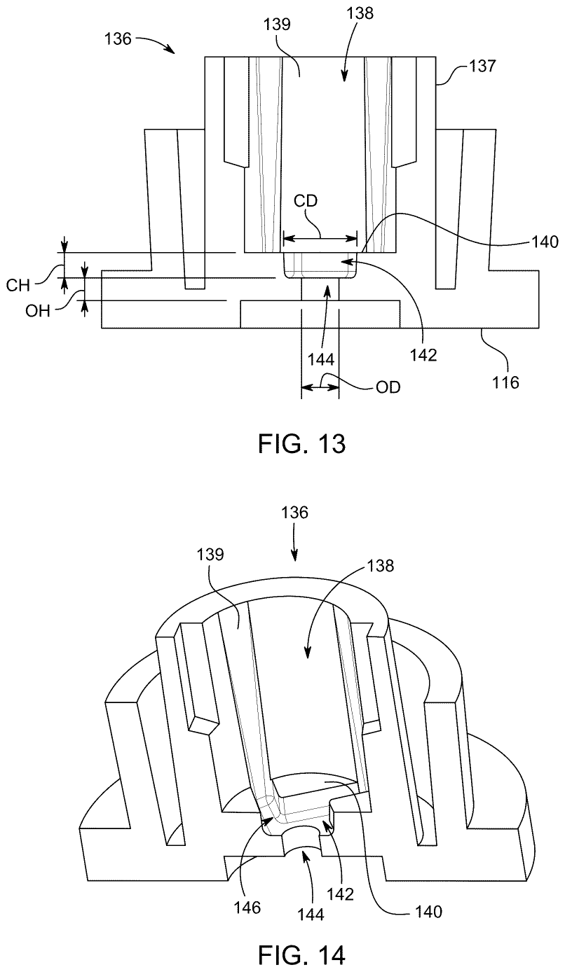

As best seen in FIGS. 11-14, nozzle insert 136 may be generally cup-shaped, having an outer surface 137, a cavity 138 with a cavity surface 139, and an end face 140. Located adjacent to end face 140 and generally concentric with the centerline of the cavity 138 is a swirl chamber 142, having a chamber diameter CD, a chamber depth CH, and defining a swirl chamber volume. The chamber diameter CD of the swirl chamber 142 may gradually decrease in size from the end face 140 to the outlet orifice 144. This may result in the swirl chamber 142 having a generally conical shape or bowl-shape. An outlet orifice 144 having an orifice diameter OD and orifice depth OH is located adjacent to and generally concentric with swirl chamber 142. Outlet orifice 144 provides fluid communication between swirl chamber 142 and the expansion chamber 200. A plurality of grooves 146 may be disposed on end face 140 of nozzle insert 136 extending generally radially inward from cavity surface 139 to swirl chamber 142. Each groove 146 connects generally tangentially with swirl chamber 142 and nozzle insert 136. Nozzle insert 136 may include two or more spaced grooves 146. Nozzle insert 136 may have three grooves 146 disposed generally radially and equidistant about swirl chamber 142. Nozzle insert 136 may have two, three, four, five, or six grooves 146.

When nozzle insert 136 has been fully assembled with inside wall 134 of nozzle body 127 such that end surface 128 and end face 140 are in contact (as best illustrated in FIG. 9), a plurality of radial vanes 148 and a supply annulus 150 are defined. Supply annulus 150 is formed between cavity surface 139 and post surface 130 and extends along at least a portion of the length of cavity surface 139 such that supply annulus 150 is in fluid communication with the one or more radial vanes 148. Radial vanes 148 may be defined by the juxta position of end surface 128 of insert post 131 and grooves 146 of nozzle insert 136.

In some configurations, as shown in FIG. 10, a plurality of grooves 146′ may be disposed on end surface 128 of insert post 131 extending generally radially inward from end surface 128 to a swirl chamber 142′. In such configurations, the radial vanes 148′ may be defined by the juxta position of grooves 146′ of the insert post 131 and the end face 140 of nozzle insert 136.

The swirl chamber 142 may be defined by a chamber diameter CD of from about 0.75 mm to about 3 mm, or from about 1 mm to about 2.5 mm. In some configurations, the chamber diameter CD may be less than or equal to 3 mm. It is contemplated that swirl chambers that have a greater CD may take a longer time to stop swirling the composition within the swirl chamber upon actuator release as compared to swirl chambers with a lesser CD. When the composition continues swirling longer within the swirl chamber, it is contemplated that this leads to large droplet formation.

The swirl chamber 142 may be defined by a swirl chamber depth CH of less than or equal to 0.6 mm, or less than or equal to 0.5 mm. It is contemplated that swirl chambers that have a greater CH may take a longer time to stop swirling the composition within the swirl chamber upon actuator release as compared to swirl chambers with a lesser CH. When the composition continues swirling longer within the swirl chamber, it is contemplated that this leads to large droplet formation.

The swirl chamber 142 may be defined by a swirl chamber volume of from about 0.05 mm to about 4.2 mm³, or from about 0.1 mm³ to about 3 mm³, or from about 0.2 mm³ to about 1.5 mm³. It is contemplated that swirl chambers that have a greater swirl chamber volume may take a longer time to stop swirling the composition within the swirl chamber upon actuator release as compared to swirl chambers with a lesser swirl chamber volume. When the composition continues swirling longer within the swirl chamber, it is contemplated that this leads to large droplet formation.

The outlet orifice 144 may be defined by an orifice diameter OD of less than or equal to 1 mm, or less than or equal to 0.9 mm, or from about 0.4 mm to about 1 mm, or from about 0.6 mm to about 0.8 mm. The outlet orifice may be defined by an orifice depth OH of less than or equal to 0.6 mm, or less than or equal to 0.5 mm, or at least 0.3 mm.

In some configurations, a ratio of chamber diameter CD to orifice diameter OD may be greater than about 1.1:1, or greater than about 2:1.

In some configurations, the radial vanes 148 may have a radial vane depth which may be less than the chamber depth CH as the radial vane feeds into the chamber. In some configurations, the radial vane depth may be less than 0.6 mm, or less than 0.5 mm, or less than 0.45 mm.

Nozzle body 127 and nozzle insert 136 may be constructed from any substantially rigid material, such as steel, aluminum, or their alloys, fiberglass, or plastic. However, for economic reasons, each may be composed of polyethylene plastic and formed by injection molding, although other processes such as plastic welding or adhesive connection of appropriate parts are equally applicable.

In operation of the aerosol foam dispenser 10, a user applies pressure to the actuator 108, which operates the valve assembly 30 to allow the composition from the container to flow through the valve assembly 30 and to the nozzle 114. When the actuator 108 is fully actuated, the valve stem is in the fully open position and a fluid flow path is formed from the container 11 and through the nozzle 114. The pressure of the propellant forces the composition from the container, through the composition delivery device 54, through the valve stem 40, and to the supply channel 132 of the manifold 129. From the supply channel 132, the composition travels into the nozzle 114, through the supply annulus 150, into the radial vanes 148, into the swirl chamber 142, through the outlet orifice 144 and into expansion chamber 200.

More specifically, the composition, upon exiting the supply channel 132, may traverse nozzle body 127 and enter supply annulus 150. The pressurized composition then passes through supply annulus 150 and is directed into the plurality of radial vanes 148. Although it is preferred that nozzle insert 136, supply channel 132 and supply annulus 150 cooperate to transport the liquid from the container to the plurality of vanes 148, it should be understood that other supply structures (e.g., channels, chambers, reservoirs etc.) may be equally suitable singly or in combination for this purpose. The composition is directed radially inward toward swirl chamber 142 and through outlet orifice 144 and into expansion chamber 200.

As the composition moves through the swirl chamber and exits through the outlet orifice, the composition is broken up into droplets. The Spray D(50) Normalized Droplet Size of the composition discharged from the outlet orifice may be from about 150 microns to about 350 microns, or from about 175 microns to about 325 microns, or from about 200 microns to about 300 microns, as measured according to the Spray Droplet Size Test Method. Without being limited by theory, it is believed that if the Spray D(50) Normalized Droplet Size of the composition discharged from the outlet orifice is less than about 150 microns, the shear induced by the composition passing through the porous barrier 222 needed to create a desirable foam height and/or foam density may not be achieved, resulting in a foam that is runny. If the Spray D(50) Normalized Droplet Size of the composition discharged from the outlet orifice is greater than about 350 microns the resulting foam may not have sufficient density and may collapse too quickly. If the foam is too runny and/or collapses prematurely and becomes liquid, the foam may not sufficiently conceal the target pest and the composition may puddle or flow away from the target pest. This may negatively affect the efficacy of the product and/or allow the pest to escape. The Spray D(90) Normalized Droplet Size of the composition discharged from the outlet orifice may be from about 450 microns to about 800 microns, or from about 500 microns to about 700 microns, or from about 550 microns to about 680 microns, as measured according to the Spray Droplet Size Test Method. To measure the Spray D(50) Normalized Droplet Size and the Spray D(90) Normalized Droplet Size, the porous barrier is removed from the actuator assembly prior to measurement.

As best seen in FIG. 8, actuator assembly 100 may comprise expansion chamber 200. The expansion chamber 200 may be positioned adjacent to the outlet orifice 144 of nozzle 114 and in fluid communication therewith. Expansion chamber 200 may be integral with the manifold 129 or may be a separate structure that is attached to the manifold 129 by mechanical means. The expansion chamber 200 may comprise a first end region 202, a second end region 204, and a sidewall 206 extending between the first and second end regions 202, 204. The first end region 202 may be in fluid communication with the outlet orifice 144. Sidewall 206 of expansion chamber 200 may comprise one or more air vents 210 extending therethrough. Air vent 210 may be configured to allow air to enter the expansion chamber 200 and aerate the composition as it passes through the porous barrier 222, aiding in foam production. The resulting foam will comprise the composition and bubbles of atmospheric air. This is in contrast to an aerosol foam dispenser that creates a foam by mixing a propellent with the composition and the resulting foam comprises the composition and bubbles of propellent. The air vent 210 may be any size or shape so long as air can enter the expansion chamber 200. In some configurations, the air vent may have a diameter of from about 0.5 mm to about 2.75 mm, or from about 1.5 mm to about 2.5 mm, or from about 1.75 mm to about 2.25 mm. It is believed that an air vent having a diameter of less than about 0.5 mm may not allow sufficient air into the expansion chamber, resulting in a low density foam which may be too runny and may not sufficiently conceal the target pest. It is further believed that an air vent diameter of greater than about 2.75 mm may allow too much air into the system, resulting in an undesirable low density/runny foam.

In some configurations, the air vent may have a vent cross-sectional area of from about 2 mm³ to about 10 mm³, or from about 3 mm³ to about 8 mm³. In some configurations, there may be a plurality of air vents and the sum of the vent cross-sectional area of the plurality of air vents may be from about from about 2 mm³ mm to about 10 mm³, or from about 3 mm³ to about 8 mm³.

In some configurations, a ratio of air vent cross-sectional area to expansion chamber volume may be from about 0.001 1/mm to about 0.1 1/mm, or from about 0.005 1/mm to about 0.08 1/mm, or from about 0.01 1/mm to about 0.075 1/mm.

In some configurations, air vent 210 may be positioned in the first end region 202 adjacent to outlet orifice 144. In some configurations, the air vent 210 may be positioned laterally outboard of the outlet orifice 144. In some configurations, air vent 210 is positioned from about 2 mm to about 5 mm from outlet orifice 144. Without being limited by theory, it is believed that if air vent 210 is positioned to close (e.g., less than about 2 mm) to porous barrier 222 (described hereinafter) there may be insufficient aeration of the composition to form a desirable foam.

In some configurations, the expansion chamber 200 may have a diameter DE of from about 3 mm to about 20 mm, or from about 5 mm to about 15 mm, or from about 8 mm to about 10 mm. In some configurations, the expansion chamber 200 may have a chamber length LE of at least 5 mm, or from about 5 mm to about 25 mm, or from about 6 mm to about 15 mm, or from about 7 mm to about 9 mm. The chamber length LE is measured from outer end surface 116 of nozzle 114 to a chamber facing surface of the porous barrier 222. Without being limited by theory, it is believed that if the chamber length LE is less than about 5 mm, the porous barrier 222 may be too close to the outlet orifice such that a foam will not be created due to lack of air introduction via the venturi effect. It is believed that if the chamber length LE is greater than the ranges described herein, the porous barrier 222 may be too far from the outlet orifice such that a poor foam (i.e., a foam that has low density and/or is runny) may be created due to poor/slow velocity of the particles in the expansion chamber. The expansion chamber 200 may be defined by an expansion chamber volume of from about 35 mm³ to about 8,000 mm³, or from about 100 mm³ to about 2,500 mm³, or from about 200 mm³ to about 1,000 mm³, or from about 300 mm³ to about 625 mm³.

The actuator assembly 100 may comprise one or more porous barriers 222 disposed within the fluid flow path in order to help convert a liquid and/or aerated composition into a foamed composition. In some configurations, the actuator assembly may comprise two porous barriers. Porous barrier 222 may comprise a plurality of substantially uniformly-sized and evenly distributed openings (also called passageways) through which an air and liquid mixture may be passed to aid in foam production as by production of turbulent flow through the passageways. The porous barrier 222 may be a perforated membrane, a screen 225 (also called a mesh), or the like. In some configurations, the screen 225 may be made of a corrosion-resistant material, such as plastic, aluminum, stainless steel, or otherwise. In some configurations, the screen 225 may be made of nylon. The passageways may be circular, oval, square, rectangular, and/or triangular in shape.

In some configurations, porous barrier 222 and/or screen 225 may be planar and oriented within or adjacent to the second end region 204 of expansion chamber 200 such that that the axis of each of the passageways is substantially aligned with the direction of flow of the composition. In some configurations, the shape of porous barrier 222 and/or screen 225 may also be concave or convex with the fluid flow, or it can be a tapered cone or pyramid, or may be positioned as a slanted plane diagonally relative to the direction of fluid flow. Porous barrier and/or screen 225 may be positioned normal to the foam flow is preferred.

Porous barrier 222 and/or screen 225 may be joined to expansion chamber 200 by any known means such as ultrasonic welding, heat staking, or any other mechanical form of joining plastics. In some configurations, porous barrier 222 and/or screen 225 may define the distal end of the expansion chamber. Porous barrier 222 and/or screen 225 may extend in a direction substantially parallel to the outer end surface 116 of nozzle 114.

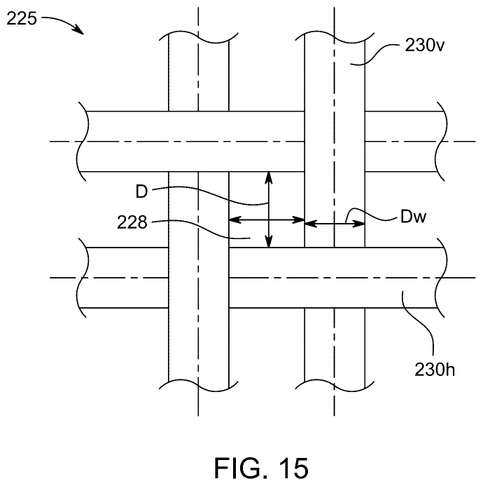

FIG. 15 shows a frontal view of passageway 228 of a screen 225, which is the void created by the intersection of horizontal wires 230h and vertical wires 230v. A screen is typically characterized by its mesh size, which is the number of passageways per linear inch counting from the center of any wire to a point exactly 1 inch distant. Equivalently, a screen can also be characterized by either its opening size and diameter of the wires, both of them specified in units of mils (thousandths of an inch) or mm, or its opening size, specified in units of mils (thousandths of an inch) or mm and its percentage open area. In some configurations, screen 225 may have a standard mesh size of, about 20 to about 40, or from about 25 to about 36.

Screen 225 may have a percent open area of from about 30% to about 55%, or from about 32% to about 53%. In some configurations, the passageway size D (width or height) of screen 225 may be from about 0.1 mm to about 1 mm, or from about 0.2 mm to about 0.9 mm, or from about 0.4 mm to about 0.8 mm. In some configurations, the diameter of the wire (Dw) comprising the screen may be from about 0.1 mm to about 1 mm, or from about 0.2 mm to about 0.9 mm, or from about 0.25 mm to about 0.8 mm. It is to be appreciated that the percent open area of screen 225 described herein may also apply to porous barrier 222.

Without being limited by theory, it is believed that a screen having a mesh size, opening size, and/or percent open area outside the ranges described herein may lead to a low density foam that lacks a consumer desirable foam height and/or foam collapse rate (i.e., collapses too fast and may not sufficiently conceal the pest, or is too dense and may not collapse fast enough and is difficult to clean up).

In use, air entering through the air vent is mixed with the liquid composition in the expansion chamber. The aerated composition then passes through one or more porous barriers, such as a screen, to refine the foam which is then dispensed. The final foam may be discharged through exit shroud 27 positioned outboard of porous barrier 222. Exit shroud 27 may be any shape that signals to the consumer that the composition is a foam, such as a cone. Exit shroud 27 may be joined to expansion chamber 200 by a mechanical means (e.g., threaded, press fit, snap fit, or the like), or may be integrally formed with the expansion chamber. Exit shroud 27 may protect porous barrier 222 and/or screen 225 from damage during use and/or shipping and/or may improve the aesthetics of the dispenser. In some configurations, portions of the exit shroud 27 may be at least partially contained within dispenser shroud 26.

The Spray D(50) Normalized droplet size of the composition discharged from the porous barrier may be in the range of about 400 microns to about 500 microns, or from about 410 microns to about 450 microns, as measured according to the Spray Droplet Size Test Method. The Spray D(90) Normalized droplet size of the composition discharged from the porous barrier may be in the range of 600 microns to about 800 microns, or from about 700 microns to about 780 microns, as measured according to the Spray Droplet Size Test Method. Without being limited by theory, it is believed that if the droplet size of the composition discharged from the porous barrier is greater than the ranges described herein, a foam may not be generated, or if a foam is generated it may be too runny. If the droplet size of the composition discharged from the porous barrier is less than the ranges described herein, the foam may be too runny and/or the foam may have a low density.

In some configurations, the Spray D(50) Normalized and/or the Spray D(90) droplet size of the composition discharged from the porous barrier is greater than the Spray D(50) Normalized and/or the Spray D(90) Normalized droplet size of the composition discharged from the outlet orifice.

In some configurations, the flow rate of the composition discharged from the actuator assembly as measured without the porous barrier present may be different from the flow rate of the composition discharged from the actuator assembly as measured with the porous barrier present. In some configurations, the flow rate of the composition discharged from the actuator assembly as measured with the porous barrier present may be less than the flow rate of the composition discharged from the actuator assembly as measured without the porous barrier present.

The flow rate of the composition discharged from the actuator assembly as measured without the porous barrier present may be from about 2 g/s to about 10 g/s, or from about 5 g/s to about 10 g/s. The flow rate of the composition discharged from the actuator assembly as measured with the porous barrier present may be from about 1 g/s to about 7 g/s, or from about 4 g/s to about 7 g/s. The flow rate can be measured according to ASTM D3069-94 (2013). Without being limited by theory, it is believed that if the flow rate of the composition discharged from the actuator assembly as measured without the porous barrier is outside of the ranges described herein, a foam may not be generated or an undesirable low density foam may be created due to the low velocity and/or no particle creation.

Without being limited by theory, it is believed that in order to achieve the flow rate as measured with the porous barrier present as described herein, about 1% to about 1.25% of the air vent volume should be open to the expansion chamber during actuation of the aerosol foam dispenser to enable enough air to be introduced, thus creating a venturi effect driving particle velocity and shear into the porous membrane/screen to create the desired foam.

### Composition

The composition may be a liquid composition. The composition may be a home care product, such as a hard floor cleaner and/or and conditioner, carpet cleaner and/or conditioner, carpet deodorizer, carpet spot cleaner, window cleaner, fabric refreshing spray (e.g., for clothing or furniture), hard surface cleaner (e.g., for dishware, sinks, countertops), and air freshener; a car care product, such as upholstery cleaner and/or conditioner, hard surface cleaner, leather cleaner, carpet cleaner, wheel cleaner, tire cleaner, and automotive glass cleaner; a personal care product, such as deodorant, body spray, foot spray, and hair spray; a pest control product, such as an herbicide, insecticide, insect barrier product, garden insecticide, and animal deterrent spray. The composition may be a pest control composition.

As used herein, “pest control” means the management of a pest species, including any animal, such as insects and other arthropods, plant, or fungus that adversely impacts human activities or the environment, where management includes controlling, killing, eliminating, repelling, or attracting the pest species. The terms “pest control” and “pesticide” are used interchangeably and it is understood that a composition or an ingredient that has “cidal” activity, e.g., pesticide, insecticide, herbicide, fungicide, may or may not kill and/or eliminate the target pest, e.g., arthropod, insect, weed, or fungus. As used herein, “cide” and “cidal” includes compositions, compounds, components, ingredients, materials, etc., which are effective to kill, remove, destroy, defoliate, exterminate, eradicate, eliminate, etc., a target pest, as well as to retard, regulate, inhibit, prevent, etc., the survival, growth, and/or proliferation of such pest. Pest control compositions may include compositions for managing a pest species inside and outside of a building, such as a dwelling or a business, including, but not limited to, areas such as garages, patios, balconies, screened porches, lawns, and/or gardens. Pest control compositions may include compositions for use in and/or on yards, lawns, bushes, trees, and/or outdoor plants, as well as for use on or around indoor plants. Pest control compositions may include selective and non-selective products and compositions, such as selective and non-selective herbicides, fungicides, and insecticides. Pest control compositions may also include compositions for topical application to humans to control or repel pest species, such as insects and other arthropods.

The composition may be an aqueous composition. The composition may comprise from about 40% to about 99%, or from about 45% to about 99%, by weight of the composition of water The composition may comprise from about 40% to about 95% water, or from about 50% to about to about 90%, or from about 55% to about 80%, or from about 58% to about 78%, or from about 60% to about 75%, or from about 62% to about 72%, all by weight of the composition.

Exemplary pest control compositions comprising water are described in U.S. application Ser. No. 17/865,943, U.S. application Ser. No. 18/082,891, U.S. application Ser. No. 18/334,004, and U.S. Provisional App. Ser. Nos. 63/509,339 and 63/509,380, all of which are hereby incorporated by reference herein.

The composition may be provided in the form of a ready-to-use composition, which can be directly applied to a target surface (e.g., as a spray) and need not be diluted by a consumer before use. Ready-to-use compositions may be preferred by some consumers, because ready-to-use compositions do not require dilution by the consumer, which may be messy, inconvenient, and/or require multiple containers. The compositions disclosed herein may contain select ingredients at select levels suitable to be sprayed directly onto a pest.

The composition may be substantially free of geologically derived (e.g., petroleum-based) oils, such as mineral oil. Compositions containing geologically derived oils, such as mineral oil, may leave a residue on a treated surface and may be generally messy to use.

The pH of the composition may be from about 3.0 to about 11.0, or from about 3.0 to about 10.0, or from about 3.0 to about 9.0, or from about 3.5 to about 9.5, or from about 4.0 to about 9.0, or from about 4.5 about 9.0, or from about 5.0 to about 8.5, or from about 5.5 to about 8.0. The pH of the composition may be adjusted using pH modifying ingredients known in the art.

The composition may comprise particles having an intensity mean particle size from about 1 nm to about 500 nm, or from about 2 nm to about 250 nm, or from about 3 nm to about 1000 nm, or from about 5 nm to about 20 nm. Intensity mean intensity particle size can be measured according to the Particle Size Test Method described hereafter.

The composition may comprise particles having a volume mean particle size from about 1 nm to about 500 nm, or from about 2 nm to about 100 nm, or from about 3 nm to about 50 nm, or from about 3 nm to about 20 nm. Volume mean intensity particle size can be measured according to the Particle Size Test Method described hereafter.

The composition may comprise particles having a number mean particle size from about 1 nm to about 500 nm, or from about 2 nm to about 250 nm, or from about 3 nm to about 100 nm, or from about 5 nm to about 20 nm. Number mean intensity particle size can be measured according to the Particle Size Test Method described hereafter.

The compositions disclosed herein may have a relatively high level of clarity (i.e., low turbidity). Some consumers prefer a clear product versus a product that is cloudy or murky (i.e., higher turbidity). The compositions may exhibit a turbidity of less than about 100 NTU, preferably less than about 20 NTU, and greater than or equal to about 0 NTU. The compositions may exhibit a turbidity of from about 1 to about 20 NTU or from about 2 to about 10 NTU. Turbidity of the compositions is measured with a laboratory turbidity meter as described in the Turbidity Method.

The compositions disclosed herein may have a reduced yellow color. Some composition ingredients, particularly some essential oils, may naturally yellow over time. Some consumers prefer a colorless or substantially colorless product versus a product that has a yellow color. The reduction of the yellow color may be measured by any colorimetric or spectrometric method known in the art. Suitable colorimetric analytical methods include, for example, the Gardner color scale (according to American Society for Testing and Materials (“ASTM”) method ASTM D1544, D6166 and/or American Oil Chemists'Society (“AOCS”) method AOCS Td-1a-64); the CIELAB color scale (according to ASTM D5386-93b); the American Public Health Association (“APHA”) color scale (according to ASTM D1209 or AOCS Td-1b-64); the Saybolt color scale (according to ASTM D156 or D6045); or the Lovibond (red) scale (according to AOCS Cc-13b-45). The CIELAB color scale may be used to quantify the color of a pest control composition. The CIELAB color scale may also be referred to as L*a*b*, a color scale defined by the International Commission on Illumination (abbreviated CIE) in 1976. The CIELAB color scale expresses color as three values: L* for perceptual lightness, and a* and b* for the four unique colors of human vision: red, green, blue, and yellow, where the b* value represents blue/yellow color. It should be noted that the present disclosure is not limited to any specific colorimetric measurement and the reduction of the yellow color observed may be measured by any suitable colorimetric method.

The composition may have a b* value from about 0 to about 15, or from about 0.01 to about 10, or from about 0.05 to about 5, or from about 0.1 to about 3. A composition with a b* value according to the disclosed ranges may be perceived by a consumer as having a colorless appearance, while b* values outside the disclosed ranges, especially b* values greater than 5, may appear yellow to a consumer, which may connote that the composition contains impurities, has degraded, and/or is unsuitable for use.

The composition may comprise renewable components. The composition may comprise from about 1%, or from about 5%, or from about 10%, or from about 20%, or from about 30%, or from about 40%, or from about 50%, to about 40%, or to about 50%, or to about 60%, or to about 70%, or to about 80%, or to about 90%, or to about 100% by weight of renewable components. The composition may be at least partially or fully bio-based. As such, the composition can comprise a bio-based carbon content of about 50% to about 100%, preferably about 70% to about 100%, more preferably about 75% to about 100%, even more preferably about 80% to about 100%, most preferably about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents or petroleum-derived surfactants.

The compositions disclosed herein may contain less than or equal to about 40% by weight VOCs, or less than or equal to about 25% by weight VOCs, or less than or equal to about 20% by weight VOCs, or less than or equal to about 15% by weight VOCs, or less than or equal to about 10% by weight VOCs. The VOC level may be from about 0.05 wt. % to about 35 wt. %, or from about 2 wt. % to 20 wt. %. VOCs can be measured according to the California Air Resources Board (CARB) Method 310 for VOC determination (May 25, 2018).

The composition, when dispensed through the aerosol foam dispenser 10, may have a spray diameter of from about 2 inches (5.08 cm) to about 6 inches (15.24 cm), or from about 3 inches (7.62 cm) to about 4.5 inches (11.43 cm), as measured according to the Spray Method described herein.

The composition, when dispensed through the aerosol foam dispenser device 10, may have a spray force of from about 2 gf to about 16 gf, or from about 4 gf to about 12 gf, or from about 6 gf to about 10 gf, as measured according to the Spray Force Method as described herein.

The composition may have a surface tension of from about 10 mN/m to about 60 mN/m as measured according to the Surface Tension Method.

The composition may have a Brookfield viscosity of from about 1 cps to about 1,000 cps, or from about 10 cps to about 750 cps, or from about 50 cps to about 500 cps.

### Active Ingredients

The composition may comprise one or more active ingredients (also referred to herein as actives). The composition may comprise from about 0.005% to about 15%, or from about 0.05% to about 12%, or from about 0.1% to about 10%, or from about 0.25% to about 8%, or from about 0.5% to about 6%, by weight of the composition, of one or more active ingredients.

Exemplary active ingredients which may be used in the composition include, but are not limited to, aldehyde C16 (pure), almond oil, terpenes, alpha-terpineol, verbenone, alpha-cedrene, cinnamic aldehyde, amyl cinnamic aldehyde, cinnamyl acetate, amyl salicylate, anisic aldehyde, cedrol, benzyl alcohol, benzyl acetate, cinnamaldehyde, cinnamic alcohol, carvacrol, caryophyllene, carveol, citral, citronellal, methylheptenone, citronellol, dimethyl salicylate, eucalyptol (also known as 1,8-cineole), thujopsene, 3-thujopsanone, α-thujone, β-thujone, fenchone, eugenyl acetate (e.g., isoeugenyl acetate), eugenol, iso-eugenol, methyl iso-eugenol, galaxolide, geraniol, guaiadiene, guaiacol, ionone, menthol (e.g., L-menthol), menthyl ester, menthone, carvone (e.g., L-carvone), camphor, camphene, p-cymene, borneol, bornyl esters, bornyl acetate, isobornyl acetate, terpinene (e.g., gamma-terpinene), methyl anthranilate, methyl ionone, methyl salicylate, nerol, phellandrene (e.g., alpha-phellandrene), pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, myrcene, chavicol, acetaldehyde, safrole, terpinen-4-ol, cineole, dimethyl trisulfide, diallyl disulfide, diallyl sulfide, diallyl tetrasulfide, 3-vinyl-[4H]-1,2-dithiin, thyme oil, thyme oil white, thyme oil red, thymol, anethole (e.g., trans-anethole), vanillin, ethyl vanillin, castor oil, cedar oil, cedarwood oil, cinnamon, cinnamon oil, citronella, citronella oil, clove, clove oil, corn oil, corn mint oil, oregano oil, cottonseed oil, garlic, garlic oil, geranium oil, lemongrass oil, linseed oil, mint, mint oil, peppermint, peppermint oil, spearmint, rose oil, spearmint oil, rosemary, rosemary oil, sesame, sesame oil, soybean oil, white pepper, licorice oil, wintergreen oil, anise oil (e.g., star anise oil), lilac flower oil, black seed oil, bay oil, grapefruit seed oil, grapefruit, lemon oil, orange oil, orange flower oil, tea tree oil, cedar leaf oil, camphor oil, Tagete minuta oil, lavender oil, Lippia javancia oil, oil of bergamot, galbanum oil, eucalyptus oil, lovage oil, and mixtures thereof.

In some aspects, the composition may comprise one or more active ingredients selected from the group consisting of eugenol, 2-phenylethyl propionate, menthol, menthone, amyl butyrate, geraniol, limonene (e.g., d-limonene), p-cymene, linalool, linalyl acetate, camphor, methyl salicylate, pinene (e.g., alpha-pinene, beta-pinene), eucalyptol, piperonal, piperonyl alcohol, tetrahydrolinalool, thymol, carvone (e.g., L-carvone), vanillin, ethyl vanillin, iso-eugenol, bornyl acetate, isobornyl acetate, terpinene (e.g., gamma-terpinene), cinnamyl acetate, cinnamic alcohol, cinnamaldehyde, ethyl cinnamate, pyrethrins, abamectin, azadirachtin, amitraz, rotenone, boric acid, spinosad, biopesticides, synthetic pesticides, and mixtures thereof.

In some aspects, the composition may comprise from about 0.15% to about 15%, or from about 0.5% to about 12%, or from about 1% to about 10%, or from about 1.5% to about 6%, by weight of the composition, of one or more active ingredients, where the active ingredient is an essential plant oil. The composition may comprise one or more essential plant oils selected from the group consisting of corn mint oil, peppermint oil, spearmint oil, rosemary oil, thyme oil, citronella oil, clove oil, cinnamon oil, cedarwood oil, garlic oil, geranium oil, lemongrass oil, and mixtures thereof, preferably selected from the group consisting of corn mint oil, spearmint oil, rosemary oil, thyme oil, and mixtures thereof, more preferably selected from the group consisting of corn mint oil, rosemary oil, and combinations thereof. In some aspects, the composition may comprise from about 1% to about 15%, by weight of the composition, of an active ingredient selected from the group consisting of geraniol, cornmint oil, lemongrass oil, rosemary oil, and mixtures thereof. In some aspects, the composition may comprise from about 0.5% to about 10%, by weight of the composition, of geraniol and/or from about 0.5% to about 5%, by weight of the composition, of cornmint oil.

The composition may comprise one or more synthetic pesticides. Exemplary synthetic pesticides include, but are not limited to, pyrethroids, such as bifenthrin, esfenvalerate, fenpropathrin, permethrin, cypermethrin, cyfluthrin, deltamethrin, allethrin, lambda-cyhalothrin, or the like; synergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. The composition may comprise less than about 10%, or less than about 5%, or less than about 2%, or less than about 1%, or less than about 0.5%, or less than about 0.1%, by weight of the composition, of a synthetic pesticide. Alternatively, the composition may be substantially free of a synthetic pesticide.

The composition may comprise one or more biopesticides. Exemplary biopesticides include, but are not limited to, pyrethrum, rotenone, neem oil, and mixtures thereof.

### PH Adjusting Agents

The compositions described herein may comprise from about 0.00001% to about 5%, or from about 0.0001% to about 2%, or from about 0.001% to about 1%, by weight of the composition, of a pH adjusting agent. In some aspects, the composition may comprise from about 0.00001% to about 1.5%, or from about 0.0001% to about 1%, or from about 0.001% to about 0.8%, or from about 0.01% to about 0.6%, by weight of the composition, of a pH adjusting agent.

Exemplary pH adjusting agents include, but are not limited to, a carboxylic acid or a salt thereof chosen from citric acid or a salt thereof, malic acid or a salt thereof, acetic acid or a salt thereof, fumaric acid or a salt thereof, humic acid or a salt thereof, or mixtures thereof, preferably citric acid or a salt thereof, more preferably citric acid anhydrous or citric acid monohydrate. The compositions described herein may comprise from about 0.00001% to about 1.5%, by weight of the composition, of citric acid or a salt thereof, such as sodium citrate, monosodium citrate, disodium citrate, trisodium citrate, trisodium citrate dihydrate, potassium citrate, monopotassium citrate, tripotassium citrate, tripotassium citrate monohydrate, or dipotassium citrate. Carboxylic acids, such as citric acid, or salts thereof may function to adjust the pH of the composition and/or as a chelant.

### Surfactant

The composition disclosed herein may be formulated with one or more surfactants. The composition may comprise from about 0.01% to about 15%, or from about 0.1% to about 12%, or from about 1% to about 10%, or from about 2% to about 8%, by weight of the composition, of one or more surfactants, preferably one or more anionic surfactants.

A sprayed drop of the composition described herein is preferably able to wet a target surface and spread out or cover a target area to perform its intended function. A surfactant generally reduces the surface tension of the water on the surface of the spray drop by reducing the interfacial tension between the spray drop and target surface, e.g., exoskeleton of an arthropod. Surfactants also wet and disperse particles of active ingredient(s) in the composition prior to spraying, thereby enabling more uniform coverage and wetting of the target arthropod upon spraying. Surfactants may also function to emulsify active agents that are not easily solubilized in water, such as oils. Surfactants may also function to create and stabilize a foam by reducing the interfacial tension between air and the liquid composition. Surfactants thus include various agents known to function as emulsifiers or wetting agents. Suitable surfactants include anionic surfactants, amphoteric surfactants, zwitterionic surfactants, nonionic surfactants, cationic surfactants, or mixtures thereof.

Anionic surfactants are surfactant compounds that contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants. Anionic surfactants include the alkali metal, ammonium and alkanol ammonium salts of organic sulfuric reaction products having in their molecular structure an alkyl or alkaryl group containing from about 8 to about 22 carbon atoms and a sulfonic or sulfuric acid ester group. Examples of such anionic surfactants include water soluble salts and mixtures of salts of alkyl benzene sulfonates having from about 8 to about 22 carbon atoms in the alkyl group (e.g., linear alkyl benzene sulfonates, such as dodecylbenzene sulfonate and salts thereof), alkyl sulfates and alkali metal salts thereof (preferably those having from about 8 to about 22 carbon atoms in the alkyl group, e.g., sodium dodecyl/lauryl sulfate), alkyl ether sulfates having from about 8 to about 22 carbon atoms in the alkyl group and about 2 to about 9 moles of ethylene oxide. Aryl groups generally include one or two rings, alkyl groups generally include from about 8 to about 22 carbon atoms, and ether groups generally comprise from about 1 to about 9 moles of ethylene oxide (EO) and/or propylene oxide (PO), preferably EO. A preferred anionic surfactant is sodium lauryl sulfate or SLS (also known as sodium dodecyl sulfate). The composition may comprise from about 0.2% to about 10%, or from about 2% to about 8.5%, or from about 4% to about 8%, by weight of the composition, of sodium lauryl sulfate.

Anionic surfactants may also include fatty acids and salts thereof. Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. The salts may be sodium, potassium, calcium, magnesium, barium, iron, ammonium and amine salts of fatty acids. The salts of fatty acids are also known as soaps. Fatty acid and the salts thereof may be linear, branched, saturated, unsaturated, cyclic, or mixtures thereof. Exemplary fatty acids and salts thereof include, but are not limited to, octanoic acid, nonanoic acid, decanoic acid, lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof.

Alternatively, the compositions may be substantially free of fatty acids, as a fatty acid may be difficult to solubilize in an aqueous composition. In particular, the compositions may be substantially free of lauric acid, oleic acid, stearic acid, or a combination thereof.

Additional suitable anionic surfactants include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, acyl methyl taurates, sulfoacetates, acyl lactates, and sulfosuccinamides.

Amphoteric surfactants are surface active agents containing at least one anionic group and at least one cationic group and may act as either acids or bases, depending on pH. Some of these compounds are aliphatic derivatives of heterocyclic secondary and tertiary amines, in which the aliphatic substituent(s) may be straight or branched, at least one of the aliphatic substituents contains from about 6 to about 20, or from about 8 to about 18, carbon atoms, and at least one of the aliphatic substituents contains an anionic water-solubilizing group, e.g., carboxy, phosphonate, phosphate, sulfonate, sulfate.

Zwitterionic surfactants are surface active agents having a positive and negative charge in the same molecule, where the molecule is zwitterionic at all pHs. Zwitterionic surfactants include betaines and sultaines. The zwitterionic surfactants generally contain a quaternary ammonium, quaternary phosphonium, or a tertiary sulfonium moiety. Zwitterionic surfactants contain at least one straight chain or branched aliphatic substituent, which contains from about 6 to 20, or from about 8 to about 18, carbon atoms, and at least one aliphatic substituent containing an anionic water-solubilizing group, e.g., carboxy, sulfonate, sulfate, phosphate or phosphonate.

Examples of suitable amphoteric and zwitterionic surfactants include, but are not limited to, the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates, where the alkyl group has from 6 to about 20 carbon atoms. Other suitable amphoteric and zwitterionic surfactants include, but are not limited to, alkyliminomonoacetates, alkyliminidiacetates, alkyliminopropionates, alkyliminidipropionates, and alkylamphopropylsulfonates, where the alkyl group has from about 12 to about 18 carbon atoms, as well as alkyl betaines, alkylamidoalkylene betaines, alklyl sultaines, and alkylamidoalkylenehydroxy sulfonates.

The nonionic surfactant(s) may be any of the known nonionic surfactants, examples of which include condensates of ethylene oxide with a hydrophobic moiety. Nonionic surfactants include ethoxylated primary or secondary aliphatic alcohols having from about 8 to about 24 carbon atoms, in either straight or branch chain configuration, with from about 2 to about 40, or from about 2 and about 9 moles of ethylene oxide per mole of alcohol. Other suitable nonionic surfactants include, but are not limited to, the condensation products of alkyl phenols having from about 6 to about 12 carbon atoms with about 3 to about 100, or 3 to about 60, or 3 to about 30, or about 5 to about 14 moles of ethylene oxide. Nonionic surfactants may also include ethoxylated castor oils and silicone surfactants, such as Silwet L-8610, Silwet L-8600, Silwet L-77, Silwet L-7657, Silwet L-7650, Silwet L-7607, Silwet L-7604, Silwet L-7600, and Silwet L-7280. Nonionic surfactants also include polyglyceryl oleate/stearate.

The compositions of the present disclosure may optionally comprise one or more cationic surfactants. Suitable cationic surfactants include quaternary ammonium surfactants and amino surfactants that are positively charged at the pH of the pest control composition.

The weight ratio of surfactant, preferably anionic surfactant, more preferably sodium lauryl sulfate, to active ingredient may be from about 1:3 to about 30:1, or about 1:3 to about 20:1, or about 1:1 to about 20:1, or about 1:1 to about 10:1, or about 1:3 to about 3:1, or about 1:2 to about 2:1, or about 1:1.5 to about 1.5:1, or about 1:1.2 to about 1.2:1. The weight ratio of surfactant, preferably anionic surfactant, more preferably sodium lauryl sulfate, to active ingredient, preferably an essential oil or a constituent thereof, may be from about 1:1 to about 30:1 or about 1:1 to about 20:1.

### Solvent

The compositions described herein may comprise from about 0.05% to about 45%, or from about 1% to about 35%, or from about 1.5% to about 25%, or from about 2% to about 20%, by weight the composition, of one or more solvents. In some aspects, the composition may comprise from about 2.5% to about 25%, by weight of the composition, of a first solvent such as isopropyl alcohol and from about 0.1% to about 10%, by weight of the composition, of a second solvent, wherein the second solvent is chosen from triethyl citrate, isopropyl myristate, propylene carbonate, ethyl lactate, butyl lactate, butyl stearate, glycerin, urea, or mixtures thereof. In some aspects, the composition may comprise from about 0.1% to about 5%, by weight of the composition, of a second solvent, wherein the second solvent is glycerin.

Suitable solvents include, but are not limited to, alcohols, such as monohydridic or polyhydridic alcohols. Preferred alcohols are low molecular weight primary or secondary alcohols exemplified by ethanol, propanol, and isopropanol, preferably isopropanol. Monohydric alcohols and polyols, such as those containing from 2 to about 6 carbon atoms and from 2 to about 6 hydroxy groups (e.g., ethylene glycol, glycerin, and 1,2-propanediol (also referred to as propylene glycol)), may also be used.

Still other suitable solvents may include urea. The pest control compositions may comprise from about 0.1% to about 10%, or from about 0.5% to about 10%, or from about 0.5% to about 8%, or from about 1% to about 6%, by weight of the composition, of urea. Without wishing to be bound by theory, urea may improve the stability, availability, and/or solubility of the one or more active ingredients in the composition, thereby improving the efficacy of the composition without increasing the concentration of VOCs. Further, urea may improve the low temperature stability of compositions containing anionic surfactants, such as SLS.

Still other suitable solvents may include esters. The composition may comprise from about 0.05% to about 15%, or from about 0.1% to about 12%, or from about 0.5% to about 10%, or from about 1% to about 7%, by weight of the composition, of one or more esters. Esters are commonly formed by reacting a carboxylic acid with a molecule comprising one or more hydroxyl groups. Examples of suitable carboxylic acids include acetic acid, formic acid, lactic acid, citric acid, malic acid, oxalic acid, propanoic acid, propiolic acid, butyric acid, isobutryic acid, caproic acid, adipic acid, benzoic acid, salicylic acid, caprylic acid and fatty acids. Exemplary molecules comprising one or more hydroxyl groups include, but are not limited to, methanol, ethanol, sorbitol, propyl alcohol, isopropyl alcohol, butyl alcohol, sec-butyl alcohol, isobutyl alcohol, tert-butyl alcohol, ethylene glycol, propylene glycol, glycerol, polyglycerol, cyclohexanol, and benzyl alcohol. Examples of suitable esters include, but are not limited to, isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentonate, polypropylene glycol (PPG) myristyl propionate, diglyceryl monooleate, and diglyceryl monostearate. In some aspects, the pest control composition may from about 0.05% to about 15%, or from about 0.1% to about 12%, or from about 0.5% to about 10%, or from about 1% to about 7%, by weight of the composition, of ethyl lactate.

Additional solvents can include lipophilic fluids, including siloxanes, other silicones, hydrocarbons, glycol ethers, glycerin derivatives such as glycerin ethers, perfluorinated amines, perfluorinated and hydrofluoroether solvents, low-volatility nonfluorinated organic solvents, diol solvents, and mixtures thereof.

Suitable solvents listed under section 25(b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), and glycerin.

Preferred solvents include isopropanol, ethanol, glycerin, ethyl lactate, renewable versions thereof, and mixtures thereof. The compositions described herein may comprise from about 0.05% to about 45%, or from about 0.5% to about 30%, or from about 1% to about 25%, or from about 1.5% to about 20%, or from about 2% to about 15%, by weight of the composition, of a solvent chosen from of isopropanol, glycerin, or mixtures thereof.

Without being bound to theory, it is also believed that the weight ratio of surfactant to solvent may affect certain foam properties and the weight ratio of surfactant to solvent may be selected to optimize these foam properties. The weight ratio of surfactant to solvent may range from about 2:1 to about 1:5, or from about 1.2:1 to about 1:4, or from about 1:1 to about 1:4, or from about 1:1 to about 1:3. The composition may comprise sodium lauryl sulfate and isopropanol, where the weight ratio of sodium lauryl sulfate to isopropanol may be from about 2:1 to about 1:5, or from about 1.2:1 to about 1:4, or from about 1:1 to about 1:3. In some aspects, the weight ratio of sodium lauryl sulfate to isopropanol may be from about 2:1 to about 1:12, or from about 1.5 to about 1:4.

### Preservatives

The compositions disclosed herein may comprise one or more preservatives. As used herein a “preservative” is any substance or compound that is added to protect against decay, decomposition, or spoilage. Preservatives may be natural or synthetic. Preservatives may be antimicrobial preservatives, which inhibit the growth of bacteria or fungi, including mold, or antioxidants. Exemplary preservatives can include potassium sorbate, sodium benzoate, tocopherol (e.g., tocopherol acetate), calcium propionate, sodium nitrate, sodium nitrite, sulfites (sulfur dioxide, sodium bisulfite, potassium hydrogen sulfite, etc.), and disodium EDTA. The compositions disclosed herein may comprise from about 0.02% to about 10%, or from about 0.05% to about 8%, or from about 0.5% to about 6%, by weight of the composition, of a preservative.

### Dye

The composition may comprise a dye or colorant. Exemplary colorants include, but are not limited to, inorganic pigments, such as ultramarine blue, organic dyes, and trace nutrients, such as salts of iron, manganese, boron, copper, cobalt, molybdenum and zinc. The composition may comprise from about 0.001% to about 0.1%, or 0.005% to about 0.05%, or 0.008% to about 0.02%, by weight of the composition, of a dye or colorant. Alternatively, the composition may be substantially free of a dye or colorant.

The composition described herein may comprise a foam or generate a foam, when dispensed from the aerosol foam dispenser, that has a specific volume ranging from about 6 ml/g to about 14 ml/g, or from about 7.5 ml/g to about 12 ml/g, or from about 8 ml/g to about 10.5 ml/g, immediately after dispensing. In some aspects, the foam may have a specific volume ranging from about 3 ml/g to about 20 ml/g, or from about 4 ml/g to about 18 ml/g, or from about 5 ml/g to about 15 ml/g, immediately after dispensing. Specific volume can be measured according to the Specific Volume Method described herein. A foam that is too “airy” (e.g., a Specific Volume greater than about 20 ml/g) may cause a consumer to apply greater amounts of the foaming pest control composition, as the concentration of actives may be too low to effectively control the pest in foams with a Specific Volume greater than 20 ml/g. Conversely, a foam with a Specific Volume less than 3 ml/g may not have sufficient aeration to sufficiently trap and/or conceal a pest.

### Methods for Controlling Weeds

In some aspects, the composition may be a pest control composition which may be used to control undesired weeds. The method for controlling weeds can comprise the steps of: (a) providing a pest control composition (e.g., an herbicide composition); and (b) contacting the weeds with an effective amount of the pest control composition. The pest control composition may be applied (e.g., by spraying as an aqueous liquid) onto a target area in an amount in the range of from about 0.5 to about 40 ml/ft, alternatively from about 0.9 to about 36 ml/ft.

The pest control composition, e.g., herbicide, may be used to inhibit the growth and/or development of weeds, such as for example dandelion, milk thistle, broadleaf plantain, white clover, green foxtail, redroot pigweed, yellow nutsedge, crabgrass, evening primrose, chickweed, common bermudagrass, morning glory, wild carrot, Italian ryegrass, umbrella sedge, or ivy. In some aspects, the pest control composition may be sprayed onto the leaves of target weeds. In some aspects, the pest control composition may be used to treat existing weeds or may be used prevent weed growth. In the latter case, the pest control composition may be used as a pre-emergent pest control.

The pest control composition may be used to control weeds that grow from a variety of surfaces. For example, the pest control composition may be sprayed on hard surfaces with openings containing dirt where weeds may be present or may develop, such as asphalt, concrete, interlocking bricks, roads, and highways. In some aspects, the pest control composition may be applied to lawns, golf course greens, or flower beds, where weeds may be present or may develop. The pest control composition, e.g., herbicide, may be applied as a single treatment or as multiple treatments, such as application on consecutive days or weeks.

### Method of Controlling an Arthropod Pest

In some aspects, the composition may be a pest control composition which may be used to control undesired arthropods such as insects. The method of controlling an arthropod pest may comprise the steps of: (i) providing a pest control composition (e.g., an insecticide composition); (ii) contacting the arthropod pest with the pest control composition(s) as described herein; (iii) optionally wiping any excess pest control composition from an adjacent surface(s). The arthropod pest may be contacted with an effective amount of the pest control composition. The optional wiping of an adjacent surface(s) may provide a cleaning benefit on the surface, due to the presence of a surfactant, such as sodium lauryl sulfate, in the composition. Optionally, the adjacent surface may be left to dry, without wiping or rinsing.

The pest control composition, e.g., insecticide, may be applied as a single treatment or as multiple treatments, such as application on consecutive days or weeks.

### Test Methods

### Brookfield Viscosity

Brookfield viscosity is measured at 23° C.±2° C. using a Brookfield LVDV-IP viscometer. The liquid is contained in a suitable glass jar, such as a 600 mL low form beaker with a width of about 9 cm and a height of about 12.4 cm, or equivalent. The rheometer is fitted with a LV-1 spindle and operated at an RPM appropriate for the viscosity of the sample. The test is conducted in accordance with the instrument's instructions.

### PH Test Method

pH is measured using a standard pH meter such as, for example, a Beckman Coulter model PHI1410 pH meter equipped with a general-purpose probe (manufactured by Beckman Coulter, Brea, California, U.S.A.). The pH meter is calibrated according to the manufacturer's instructions. Measurements are performed after storing the compositions at room temperature (approximately 23° C.±2° C.) for approximately 24 hours.

### Particle Size Test Method

Particle size is measured by light scattering data techniques. Particle size is determined with a Malvern Zetasizer Nano ZSP (Malvern Panalytical, Malvern, United Kingdom), or the like. The software used for control of the instrument and for data acquisition is the Malvern Zetasizer Software version 8.01.4906 (Malvern Panalytical). All samples are kept at 25° C., unless otherwise specified.

Samples are measured in BRAND® polystyrene disposable cuvettes (Cat. No. 759070D or equivalent). 1 mL of the sample is added into the cuvette using a disposable transfer pipette (VWR, Cat. No. 414004-004 or equivalent), swirled, and then discarded. Another 1 mL of the sample is added into the cuvette using a disposable transfer pipette. The cap is placed on the cuvette and all sides of the cuvette are wiped with lint-free lens paper. The cuvette is loaded into the instrument in accordance with the manufacture's specification to ensure light is passing correctly into the sample during the measurement, and the lid is closed.

The instrument is readied in accordance with manufacture's specification. The particle size measurements are made through the software with the following settings:
1) Under the ‘Measure’ section, the ‘Manual’ option is selected. ‘Measurement Type’ is then set to ‘Size’.
2) The ‘Sample’ section is then selected. In the ‘Material’ subsection: ‘Material’ is chosen to be ‘SDS’; the ‘RI’ is set to 1.461; and the ‘Absorption’ is set to 0.001. In the ‘Dispersant’ subsection: ‘Dispersant’ is selected as ‘Water’; ‘Temperature’ is set to 25.0 deg C.; ‘Viscosity’ is set at 0.8872 cP; and ‘RI’ is set as 1.330. In the ‘General options’subsection ‘Mark-Houwink Parameters’ is selected, ‘A Parameter’ is set to 0.428; and ‘K Parameter (cm2/s)’ is set to 7.67e-05. In the ‘Temperature’ subsection: ‘Temperature’ is set as 25.0 deg C.; ‘Equilibration Time (second)’ is set to 120. In the ‘Cell’ subsection: ‘Cell Type’ is selected to be ‘Disposable cuvettes’; and the ‘DTS0012’ option is selected.
3) The ‘Measurement’ section is then selected. The ‘Angle of Detection Measurement Angle’ is selected as ‘173o Backscatter (NIBS default)’; ‘Measurement Duration’ is selected as ‘Automatic’; ‘Number of Runs’ is set to 11; ‘Run duration (seconds)’ is set to 10; ‘Number of Measurements’is set as 3; ‘Delay between Measurements (seconds)’ is set to 0; ‘Append Measurement Number to Sample Name’ is selected; and ‘Allow Results to be Saved Containing Correlation Data Only’ is not selected. In the ‘Advanced’ subsection: ‘Measurement duration, Extend Duration for Large Part’ is set to ‘No’; ‘Measurement settings, Positioning method’ is set to ‘Seek for Optimum Position’; and Automatic attenuation selection is set to ‘Yes’.
4) The ‘Data Processing’ section is then selected, and the following options are selected: ‘Analysis Model’ is selected as ‘General Purpose (Normal Resolution)’. The ‘Size Analysis Parameters’ are set to: ‘Analysis Details’; ‘Name’ is set to ‘Customized’, ‘Description’ is set to ‘Customized Analysis’; ‘Display Range’ is set with the ‘Lower Limit’ set to 0.6 and ‘Upper Limit’ set to 6000; ‘Multimodal—analysis, Resolution’ is selected to ‘Normal’; ‘Size classes, Number of size classes’ is set as 70; ‘Lower Size Limit’ is set as 0.4; ‘Upper Size Limit’ is set as 10,000; ‘Lower Threshold’ is set as 0.05; and ‘Upper Threshold’ is set as 0.01. In the ‘Reports’ subsection: ‘Print Report’ is not selected and in the ‘Export’ subsection: ‘Export’ results is not selected.

### Spray Droplet Size Test Method

The term “Dv50 value” describes the average particle size where 50 vol. % of the particles have a smaller size, and the term “Dv90 value” describes the average particle size where 90 vol. % of the particles have a smaller size.

Spray droplet volume size distribution measurements comprising Spray D(50) Normalized and Spray D(90) Normalized values are determined using a Malvern Spraytec 2000 laser diffraction spray droplet sizing instrument (supplied by Malvern Instruments, Worcestershire, UK), equipped with a 300 mm lens possessing a focal length of the 150 mm, and an Air Purge System (not greater than 14.5 psi). The system is controlled with a computer and software accompanying the instrument, such as the Spraytec software version 3.20 or equivalent, utilizing Mie Theory and Fraunhofer Approximation optical theory. The system is placed in a fume hood for atmospheric control with care taken to place it directly opposite the actuation spray plume trajectory to prevent saturation, with an air flow rate of between 50-70 L/min (60 L/min was the target rate). The distance from the dispensing nozzle orifice to the laser during measurements is 30 cm. A new spray bottle is used for each sample replicate analyzed. Lighting conditions are not changed during or between the background control and test sample data collection periods. Light obscuration values below 95% are considered suitable to provide accurate results.

Samples are tested within three hours of preparation and are measured at temperatures between 20-22° C. Deionized water is used as a standard reference spray and is labeled as the “control.”

Spray measurements are conducted using the following spray SOP instrument configuration: Rapid SOP type is chosen, and the following settings are selected: Hardware Configuration is set to “Default”, Measurement Type is set to “Rapid”, Data Acquisition Rate is set to “250 Hz”, and Lens Type is set to “300”. Within the Measurement menu: Background is set to “3 seconds”, Inspection is selected, the box under Output Trigger is Unchecked. Under the Measurement tab “Rapid” is selected, Events Number is set to “1”, Duration Per Event is set to “4000.0”, Units is set to “ms”. Measurement Trigger where Trigger Type is set to “Transmission drops to level” and Transmission is set to “96”, Data Collection where Start is set to “52”, Units is set to “ms”, and select “before the trigger” from the drop down menu. On the Advanced tab window, all boxes are Unchecked, and Grouping is “no grouping”; The Background Alarms are set to “default values”. On the Analysis Tab and under Optical Properties, Particle Set is set to “Water”, Dispersant set to “Air”, Multiple Scattering Analysis is set to “Enable”. On the Data Handling tab and under Detector Range is set to “first: 1 and last: last”, “No extinction analysis” box is selected, Scattering threshold is set to “1”. On the Data Handling/Spray Profile the Path Length is set to “100.0”, the Alarm is selected, and the “Use default values” box is checked. On the Additional Properties tab the Curve Fit is set to “no fit”, User Size is set to “enable box”, the drop down menu is set to “Default”. On the Additional Properties/Advanced tab Particle Diameter is set to “0.10” for the minimum and to “900” for the maximum, and Result Type is set to “Volume Distribution”. On the Output tab, Export Option is set to “not selected”, the Derived Parameter is selected, the Use Averaging Period box is selected and set to “0.0” and “ms”. On the Average menu “Average scatter data” is selected.

Spray measurements are conducted using the following Spray Procedure: The sample is first test sprayed from the spray bottle for 1-2 seconds, to ensure that the nozzle is free flowing and not clogged; the sample is loaded into the holding device in the front of the Spraytec 2000 system. The actuator is fully depressed. The spray droplet size data are viewed and saved as “Average Scatter Data”.
a. The value obtained from each sample measurement is normalized to the control sample value in accordance with the following calculations:

$$The value of Spray D ( 50 ) Normalized = {D ( 50 )}_{Example} / {D ( 50 )}_{Control} ;$$

$$The value of Spray D ( 90 ) Normalized = {D ( 90 )}_{Example} / {D ( 90 )}_{Control} ;$$

wherein:

Spray D(50) and Spray D(90) are values obtained from the instrument software for both the example samples and control samples separately.

Each of the Spray D(50) Normalized Spray D(90) Normalized values reported for each of the samples is the average value calculated from five replicate spray plumes per sample.

### Determination of the Hunter L.a.b. (CIE) b* Value

The formation of yellow color is measured using the Hunter L.a.b. (CIE) method. The b* value is determined using a HunterLab ColorFlex EZ® spectrophotometer (HunterLab, 11491 Sunset Hills Road, Reston, Virginia 20190). The methodology that is used is described in detail in the “User's Manual for ColorFlex EZ Version 2.2.”

The HunterLab ColorFlex EZ® spectrophotometer uses a xenon flash lamp to illuminate a sample. The light reflected from the sample is then separated into its component wavelengths through a dispersion grating. The relative intensities of the light at different wavelengths along the visible spectrum (400-700 nm) are then analyzed to produce a number result indicative of the color of the sample.

### Turbidity Method

A turbidimeter is used to measure the turbidity of the compositions. This instrument measures the turbidity of liquids in Nephelometric Turbidity Units (NTU). The method of measuring turbidity is described in detail in the following reference: Hach 2100Q and 2100Qis User Manual, Edition 6, 08/2021, from the Hach Company. If a sample is not homogenous prior to analysis, the sample is inverted until it appears homogenous and is then poured into an analyte vile for measurement.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

### Surface Tension Method

Surface tension is measured according to ASTM 1331-14 (Published January 2015) using an EZ-Pi tensiometer (Kibron, Parrish, Fla.), or equivalent. The instrument is calibrated according to the manufacturer instructions using DI water. Measurements are taken and values are reported in mN/m.

### Spray Force Method

Spray force is measured using a digital force gauge with a 2.5N capacity load cell, for example, an Advanced Force Gauge available from Mecmesin, or equivalent. A plate mounted to a probe with a minimum 6-inch diameter is assembled to the force gauge and is positioned perpendicular to the exit nozzle of the actuator flow path. The sample is placed in a water bath to 22° C. for 5 minutes to normalize the sample to the test environment prior to testing. The sample is then placed at a distance of 12 inches from the probe. The sample is sprayed for three, one second sprays (with a delay between sprays of approximately two seconds). Click the “Start” icon with the start of the first spray. Click the “Stop” icon after the third spray. Take the three peak force measurements and record the average to the nearest 0.01 gf. In like fashion, the procedure is repeated for three replicate test specimens. The average peak among the three replicates is calculated and reported as Spray Force to the nearest gf.

### Spray Diameter Method

The spray pattern may be important as it impacts how easy it is for consumers to spray a pest and how much of the pest control composition is applied to a pest during a spray event. A smaller spray diameter, or more localized spray, may make it difficult for a user to accurately spray the pest. A larger spray diameter, or mistier spray, can result in too much of the composition landing on surface adjacent to the pest rather than the pest. This can lead to a larger mess the consumer may need to clean up. Given the general size of a pest and the distance one can comfortably hold the container away from the pest, a spray diameter of about 2 inches to about 6 inches may be desirable.

Spray diameter is measured using thermal sensitive paper mounted on a rigid test stand. Test samples are equilibrated to 20 to 24° C. The test can is placed perpendicular +/−10° to the paper at a distance of 12 inches. After spray is completed, the test paper is scanned and analyzed with imaging software. The outside diameter of the spray is calculated by:

$$Diameter = 2 * ( “ area ” / 3.141593 ) \hat{} 0.5$$

Where “area” is the cell location in the imaging software containing the outside diameter area.

### Specific Volume Method

Specific volume is measured by dispensing a 3 second aerosol spray of product into a 500 mL graduated cylinder. The initial volume after being sprayed is recorded in mL. The mass of product dispensed is measured by subtracting the initial weight of the cylinder before dispensing product from the weight of the cylinder after product has been dispensed in units of grams. The volume determined above is divided by the mass of product dispensed to determine the specific gravity in units of mL/g. All measurements are performed in a laboratory maintained at 23° C.±2° C. and 50%±2% relative humidity and test products are conditioned in this environment for at least 2 hours prior to testing. In like fashion, the procedure is repeated for three replicate test specimens. The average peak among the three replicates is calculated and reported as Specific Volume to the nearest mL/g.

### Combinations

Paragraph A. An aerosol foam dispenser comprising:
   a. a pressurized container configured to contain a composition and a propellant;
   b. a valve assembly in fluid communication with the container; and
   c. an actuator assembly comprising:
      i. a supply channel in fluid communication with the valve assembly;
      ii. a nozzle in fluid communication with the supply channel and configured to atomize the composition, the nozzle comprising:
         1. a substantially cup-shaped nozzle insert having an outlet orifice; and
         2. a nozzle body for receiving and retaining the nozzle insert, the nozzle body in fluid communication with the supply channel for receiving a composition to be atomized and comprising an insert post having an end surface;
         wherein the nozzle comprises a swirl chamber in fluid communication with a plurality of generally radial vanes and the outlet orifice disposed generally concentric with the swirl chamber and in fluid communication therewith, wherein the plurality of radial vanes is in fluid communication with the supply channel;
      iii. an expansion chamber comprising a side wall, a first end region, and a laterally opposing second end region, wherein the first end region is in fluid communication with the outlet orifice, and wherein the side wall comprises an air vent extending therethrough;
      iv. a porous barrier extending in a direction substantially parallel to an outer end surface of the nozzle, wherein the porous barrier is positioned adjacent to the second end region of the expansion chamber; and
      v. an actuator in operative communication with the valve assembly.
Paragraph B. The aerosol foam dispenser of Paragraph A, wherein the container comprises a liquid composition and a propellant.
Paragraph C. The aerosol foam dispenser of Paragraph B, wherein the liquid composition is a pest control composition.
Paragraph D. The aerosol foam dispenser of Paragraph C, wherein the liquid composition comprises: i) from about 0.2% to about 10% by weight of the composition of sodium lauryl sulfate; ii) from about 0.005% to about 15% by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof; and iii) from about 50) to about 90% by weight of the composition of water.
Paragraph E. The aerosol foam dispenser of any of Paragraphs A-D, wherein the propellant is a compressed gas, preferably nitrogen.
Paragraph F. The aerosol foam dispenser of any of Paragraphs A-E, further comprising a composition delivery device, wherein the composition delivery device is a bag or a piston and the propellant is a liquified gas.
Paragraph G. The aerosol foam dispenser of any of Paragraphs A-F, wherein a Spray D(50) Normalized droplet size of the composition discharged from the outlet orifice is in the range of about 150 microns to about 350 microns, as measured according to the Spray Droplet Size Test Method.
Paragraph H. The aerosol foam dispenser of any of Paragraphs A-G, wherein a Spray D(50) Normalized droplet size of the composition discharged from the porous barrier is in the range of about 400 microns to about 500 microns, as measured according to the Spray Droplet Size Test Method.
Paragraph I. The aerosol foam dispenser of any of Paragraphs A-H, wherein a Spray D(90) Normalized droplet size of the composition discharged from the outlet orifice is in the range of about 450 microns to about 800 microns, as measured according to the Spray Droplet Size Test Method.
Paragraph J. The aerosol foam dispenser of any of Paragraphs A-I, wherein a Spray D(90) Normalized droplet size of the composition discharged from the porous barrier is in the range of about 600 microns to about 800 microns, as measured according to the Spray Droplet Size Test Method.
Paragraph K. The aerosol foam dispenser of any of Paragraphs A-J, wherein the porous barrier is a screen having a percent open area of from about 30% to about 55%, preferably from about 32% to about 53%.
Paragraph L. The aerosol foam dispenser of any of Paragraphs A-K, wherein the expansion chamber has a volume of from about 35 mm³ to about 8,000 mm³
Paragraph M. The aerosol foam dispenser of any of Paragraphs A-L, wherein the nozzle insert comprises an outer surface and a cavity extending along a longitudinal axis L with an end face, wherein the nozzle insert comprises a plurality of generally radial grooves disposed on the end face, wherein the plurality of generally radial vanes are substantially defined by an end surface of the insert post and the grooves.
Paragraph N. The aerosol foam dispenser of any of Paragraphs A-L, wherein the insert post comprises an end surface, wherein the insert post comprises a plurality of generally radial grooves disposed on the end surface, wherein the plurality of generally radial vanes are substantially defined by the grooves and an end face of the nozzle insert.
Paragraph O. The aerosol foam dispenser of any of Paragraphs A-N, wherein a flow rate of the composition discharged from the actuator assembly as measured without the porous barrier present is in the range of about 2 g/s to about 10 g/s, preferably about 5 g/s to about 10 g/s; and wherein a flow rate of the composition discharged from the actuator assembly as measured with the porous barrier present is in the range of about 1 g/s to about 7 g/s, preferably about 4 g/s to about 7 g/s.
Paragraph P. The aerosol foam dispenser of any of Paragraphs B-O, wherein the composition has a surface tension of from about 10 mN/m to about 60 mN/m.
Paragraph Q. The aerosol foam dispenser of any of Paragraphs A-P, wherein the swirl chamber defines a volume, wherein the volume of the swirl chamber is from about 0.05 mm³ to about 4.2 mm³, preferably from about 0.1 mm³ to about 3 mm³, more preferably from about 0.2 mm³ to about 1.5 mm³.
Paragraph R. The aerosol foam dispenser of any of Paragraphs A-Q, wherein the aerosol foam dispenser further comprises an exit shroud positioned outboard of the porous barrier.
Paragraph S. The aerosol foam dispenser of any of Paragraphs A-R, wherein the air vent has a vent diameter of from about 0.5 mm to about 2.75 mm.
Paragraph T. The aerosol foam dispenser of any of Paragraphs A-S, wherein the expansion chamber has a chamber length of from about 5 mm to about 25 mm, preferably from about 6 mm to about 15 mm, more preferably from about 7 mm to about 9 mm.
Paragraph U. The aerosol foam dispenser of any of Paragraphs B-T, wherein the composition has a viscosity of from about 1 cps to about 1,000 cps.
Paragraph V. The aerosol foam dispenser of any of Paragraphs A-U, wherein the actuator is a push-button or trigger.
Paragraph W. The aerosol foam dispenser of any of Paragraphs A-V, wherein the porous barrier is a screen, wherein the screen has a plurality of passageways having a width of from about 0.1 mm to about 1 mm.
Paragraph X. A method of controlling a pest, the method comprising: providing the aerosol foam dispenser of Paragraph A; and applying the pest control composition to a pest; wherein the pest control composition is dispensed from the aerosol foam dispenser as a foam.
Paragraph Y. The method of Paragraph X, wherein the foam comprises atmospheric gas or air.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. An aerosol foam dispenser comprising:
a. a container;
b. a valve assembly in fluid communication with the container; and
c. an actuator assembly comprising:
i. a supply channel in fluid communication with the valve assembly;
ii. a nozzle in fluid communication with the supply channel and configured to atomize the composition, the nozzle comprising:
1. a substantially cup-shaped nozzle insert having an outlet orifice; and
2. a nozzle body for receiving and retaining the nozzle insert, the nozzle body in fluid communication with the supply channel for receiving a composition to be atomized and comprising an insert post having an end surface;
wherein the nozzle comprises a swirl chamber in fluid communication with a plurality of generally radial vanes and the outlet orifice disposed generally concentric with the swirl chamber and in fluid communication therewith, wherein the plurality of radial vanes is in fluid communication with the supply channel;
iii. an expansion chamber comprising a side wall, a first end region, and a laterally opposing second end region, wherein the first end region is in fluid communication with the outlet orifice, and wherein the side wall comprises an air vent extending therethrough;
iv. a porous barrier extending in a direction substantially parallel to an outer end surface of the nozzle, wherein the porous barrier is positioned adjacent to the second end region of the expansion chamber; and
v. an actuator in operative communication with the valve assembly.

2. The aerosol foam dispenser of claim 1, wherein the container contains a liquid composition and a propellant.

3. The aerosol foam dispenser of claim 2, wherein the liquid composition is a pest control composition.

4. The aerosol foam dispenser of claim 3, wherein the liquid composition comprises:
a. from about 0.2% to about 10% by weight of the composition of sodium lauryl sulfate;
b. from about 0.005% to about 15% by weight of the composition of an active ingredient selected from the group consisting of cornmint oil, peppermint oil, spearmint oil, rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, and mixtures thereof; and
c. from about 50% to about 90% by weight of the composition of water.

5. The aerosol foam dispenser of claim 1, wherein a Spray D(50) Normalized droplet size of the composition discharged from the outlet orifice is in the range of about 150 microns to about 350 microns, as measured according to the Spray Droplet Size Test Method.

6. The aerosol foam dispenser of claim 5, wherein a Spray D(50) Normalized droplet size of the composition discharged from the porous barrier is in the range of about 400 microns to about 500 microns, as measured according to the Spray Droplet Size Test Method.

7. The aerosol foam dispenser of claim 2, wherein the propellant is nitrogen.

8. The aerosol foam dispenser of claim 1, further comprising a composition delivery device, wherein the composition delivery device is a bag or a piston, and the propellant is a liquified gas.

9. The aerosol foam dispenser of claim 1, wherein the porous barrier is a screen, wherein the screen has a percent open area of from about 30% to about 55%.

10. The aerosol foam dispenser of claim 1, wherein the expansion chamber has a volume of from about 35 mm³ to about 8,000 mm³.

11. The aerosol foam dispenser of claim 10, wherein the air vent has a vent diameter of from about 0.5 mm to about 2.75 mm.

12. An aerosol foam dispenser comprising:
a. a container configured to contain a composition and a compressed gas propellant, wherein the pressure in the container is from about 170 kPa to about 1150 kPa at 21° C.;
b. a valve assembly in fluid communication with the container;
c. an actuator assembly comprising:
i. a supply channel in fluid communication with the valve assembly;
ii. a nozzle in fluid communication with the supply channel and configured to atomize the composition, the nozzle comprising:
1. a substantially cup-shaped nozzle insert having an outlet orifice; and
2. a nozzle body for receiving and retaining the nozzle insert, the nozzle body in fluid communication with the supply channel for receiving a composition to be atomized and comprising an insert post having an end surface; and
wherein the nozzle comprises a swirl chamber in fluid communication with a plurality of generally radial vanes and the outlet orifice disposed generally concentric with the swirl chamber and in fluid communication therewith, wherein the plurality of radial vanes is in fluid communication with the supply channel;
iii. an expansion chamber comprising a side wall, a first end region, and a laterally opposing second end region, wherein the first end region is in fluid communication with the outlet orifice, and wherein the side wall comprises an air vent extending therethrough;
iv. a porous barrier extending in a direction substantially parallel to an outer end surface of the nozzle, wherein the porous barrier is positioned adjacent to the second end region of the expansion chamber; and
v. an actuator in operative communication with the valve assembly;
wherein a flow rate of the composition discharged from the actuator assembly as measured without the porous barrier present is in the range of about 2 g/s to about 10 g/s; and
wherein a flow rate of the composition discharged from the actuator assembly as measured with the porous barrier present is in the range of about 1 g/s to about 7 g/s.

13. The aerosol foam dispenser of claim 12, wherein the container comprises a liquid composition and a compressed gas propellant.

14. The aerosol foam dispenser of claim 13, wherein the liquid composition is a pest control composition.

15. The aerosol foam dispenser of claim 12, wherein the nozzle insert comprises an outer surface and a cavity extending along a longitudinal axis with an end face, wherein the nozzle insert comprises a plurality of generally radial grooves disposed on the end face, wherein the plurality of generally radial vanes is substantially defined by the end surface of the insert post and the grooves.

16. The aerosol foam dispenser of claim 12, wherein the insert post comprises a plurality of generally radial grooves disposed on the end surface of the insert post, wherein the plurality of generally radial vanes is substantially defined by the grooves and an end face of the nozzle insert.

17. The aerosol foam dispenser of claim 13, wherein the liquid composition has a surface tension of from about 10 mN/m to about 60 mN/m.

18. The aerosol foam dispenser of claim 12, wherein the aerosol foam dispenser further comprises an exit shroud positioned outboard of the porous barrier.

19. The aerosol foam dispenser of claim 12, wherein the air vent has a vent area of from about 2 mm³ mm to about 3 mm³.

20. An aerosol foam dispenser comprising:
a. a container;
b. a valve assembly in fluid communication with the container; and
c. an actuator assembly comprising:
i. a supply channel in fluid communication with the valve assembly;
ii. a nozzle in fluid communication with the supply channel and configured to atomize the composition, the nozzle comprising:
1. a substantially cup-shaped nozzle insert having an outlet orifice; and
2. a nozzle body for receiving and retaining the nozzle insert, the nozzle body in fluid communication with the supply channel for receiving a composition to be atomized and comprising an insert post having an end surface;
wherein the nozzle comprises a swirl chamber in fluid communication with a plurality of generally radial vanes and an outlet orifice disposed generally concentric with the swirl chamber and in fluid communication therewith, wherein the plurality of radial vanes is in fluid communication with the supply channel;
iii. an expansion chamber comprising a side wall, a first end region and a laterally opposing second end region, wherein the first end region is in fluid communication with the outlet orifice, wherein the side wall comprises an air vent extending therethrough;
iv. a screen extending in a direction substantially parallel to an outer end surface of the nozzle, wherein the screen is positioned adjacent to the second end region of the expansion chamber, the screen having a mesh size of from about 20 to about 40; and
v. an actuator in operative communication with the valve assembly;
wherein the expansion chamber has a chamber length from about 5 mm to about 25 mm.
